(19) United States
(12) Patent Application Publication
(10) Pub. No.: US 2022/0413990 A1
(43) Pub. Date: Dec. 29, 2022

(54) INFORMATION PROCESSING APPARATUS AND INFORMATION PROCESSING METHOD

(71) Applicant: FUJITSU LIMITED, Kawasaki-shi (JP)

(72) Inventor: Masaaki Noro, Kawasaki (JP)

(73) Assignee: FUJITSU LIMITED, Kawasaki-shi (JP)

(21) Appl. No.: 17/697,330

(22) Filed: Mar. 17, 2022

(30) Foreign Application Priority Data
Jun. 29, 2021 (JP) 2021-108175

(51) Int. Cl. G06F 11/36

(52) U.S. Cl. CPC G06F 11/3604

(57) ABSTRACT

A non-transitory computer-readable recording medium stores a program that causes a computer to execute a process, the process includes acquiring a first log using a first program that monitors a first function for securing resources managed by an operating system (OS), the first log including information that allows for identification of a resource secured by software and a time point when the software secures the secured resource, acquiring a second log using a second program that monitors a second function for releasing the resources managed by the OS, the second log including information that allows for identification of a resource released by the software and a time point when the software releases the released resource, and outputting a first time point when the software secures a target resource in association with a second time point when the target resource is released, based on the first log and the second log.

### CROSS-REFERENCE TO RELATED APPLICATION

This application is based upon and claims the benefit of priority of the prior Japanese Patent Application No. 2021-108175, filed on Jun. 29, 2021, the entire contents of which are incorporated herein by reference.

### FIELD

The embodiment discussed herein is related to an information processing apparatus and an information processing method.

### BACKGROUND

There is a system in which an application provides a service by securing and utilizing a shared resource such as a file or a database (DB) via each process of a plurality of processes. In this system, resource contention caused by two or more different processes may occur, leading to a performance deterioration of the application. Therefore, in some cases, it may be desirable to examine resource contention and conduct a performance verification of the application in advance when developing the application.

As a related art, there is a technique, for example, to generate a selected number of resource templates and assign a resource determined by one resource template of the resource templates to each client device that makes a request. There is a technique to assign a shared resource to a virtual machine (VM) through a priority evaluation based on a service level agreement (SLA), for example.

Japanese National Publication of International Patent Application No. 2015-504562 and U.S. Patent Publication No. 2019/0347122 specification are disclosed as related art.

### SUMMARY

According to an aspect of the embodiment, a non-transitory computer-readable recording medium stores a program that causes a computer to execute a process, the process includes acquiring a first log using a first program that monitors a first function for securing resources managed by an operating system (OS) among functions possessed by the OS, the first log including information that allows for identification of a resource secured by software and a time point when the software secures the secured resource, acquiring a second log using a second program that monitors a second function for releasing the resources managed by the OS among the functions possessed by the OS, the second log including information that allows for identification of a resource released by the software and a time point when the software releases the released resource, and outputting a first time point when the software secures a target resource of the resources managed by the OS in association with a second time point when the target resource is released, based on the acquired first log and the acquired second log.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an information processing method according to an embodiment;

FIG. 2 is a diagram illustrating an example of an application performance verification system;

FIG. 3 is a diagram illustrating an example of contents of a model;

FIG. 4 is a block diagram illustrating a hardware configuration example of an information processing apparatus;

FIG. 5 is a diagram illustrating an example of stored content of a model management table;

FIG. 6 is a diagram illustrating a specific example of the model management table;

FIG. 7 is a diagram illustrating an example of a normal distribution;

FIG. 8 is a diagram illustrating an example of an exponential distribution;

FIG. 9 is a diagram illustrating an example of stored contents of a first monitoring point management table;

FIG. 10 is a diagram illustrating an example of stored contents of a second monitoring point management table;

FIG. 11 is a diagram illustrating an example of a method of identifying a parameter C;

FIG. 12 is a diagram illustrating an example of stored contents of a C judging criterion management table;

FIG. 13 is a diagram illustrating an example of method of identifying a parameter D;

FIG. 14 is a diagram illustrating an example of stored contents of a D judging criterion management table;

FIG. 15 is a block diagram illustrating a functional configuration example of the information processing apparatus;

FIG. 16 is a diagram (part 1) illustrating a first operation example of the application performance verification system;

FIGS. 17A to 17D are diagrams (part 2) illustrating the first operation example of the application performance verification system;

FIG. 18 is a diagram (part 3) illustrating the first operation example of the application performance verification system;

FIG. 19 is a diagram (part 4) illustrating the first operation example of the application performance verification system;

FIG. 20 is a diagram (part 5) illustrating the first operation example of the application performance verification system;

FIG. 21 is a flowchart illustrating an example of a first monitoring process procedure;

FIG. 22 is a flowchart illustrating an example of a calculation process procedure;

FIG. 23 is a flowchart (part 1) illustrating an example of an analysis process procedure;

FIG. 24 is a flowchart (part 2) illustrating an example of the analysis process procedure;

FIG. 25 is a flowchart illustrating an example of a first selection process procedure;

FIG. 26 is a diagram illustrating a second operation example of the application performance verification system;

FIG. 27 is a flowchart illustrating an example of a second selection process procedure;

FIG. 28 is a flowchart illustrating an example of an estimation process procedure;

FIG. 29 is a diagram illustrating a third operation example of the application performance verification system;

FIG. 30 is a flowchart illustrating an example of a second monitoring process procedure; and

FIG. 31 is a flowchart illustrating an example of a third monitoring process procedure.

### DESCRIPTION OF EMBODIMENT

With the related art, it is difficult to examine resource contention and conduct a performance verification of an application. For example, it is possible to examine the resource contention and conduct the performance verification of the application after a development process of the application proceeds to a development process where a load test using test data is feasible, by causing the resource contention to actually occur through the load test. This is likely to result in a large volume of rework, however.

With reference to the drawings, an embodiment will be described in detail below.

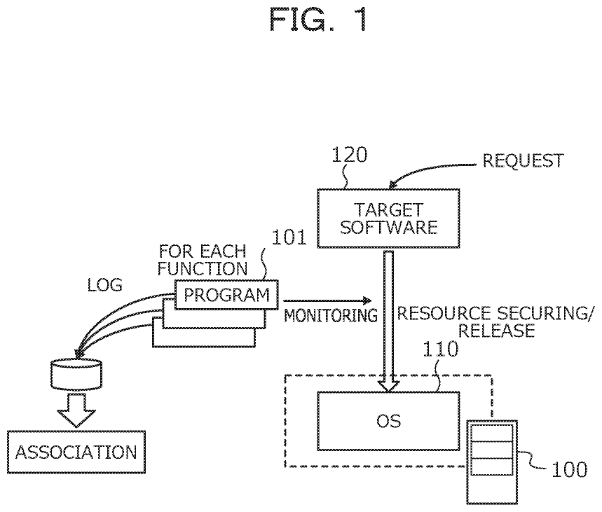

FIG. 1 is a diagram illustrating an example of an information processing method according to the embodiment. An information processing apparatus 100 is a computer that makes it easy for an application developer to examine presence or absence of resource contention caused by software related to the application, properties thereof, or the like.

A resource is a DB, a file, or the like, for example. The software is a process, a thread, or the like, for example. The process, the thread, or the like is started by the application, for example.

There is a system in which an application provides a service by securing and utilizing a shared resource such as a file or a DB via each process of a plurality of processes. In this system, resource contention caused by two or more different processes may occur, leading to a performance deterioration of the application. Therefore, in some cases, it may be desirable to examine presence or absence of the resource contention, properties thereof, or the like and conduct a performance verification of the application in advance when developing the application.

However, it is difficult to examine the presence or absence of the resource contention, properties thereof, or the like and conduct the performance verification of the application. For example, it is possible to examine the presence or absence of the resource contention, properties thereof, or the like and conduct the performance verification of an application after a development process of the application proceeds to a development process where a load test using test data is feasible, by causing the resource contention to actually occur through the load test.

For example, by referring to trace information and a source code of the application, the developer examines the presence or absence of resource contention, properties thereof, or the like and conducts the performance verification of the application. The trace information is obtained by monitoring a call from the application to a function of an operating system (OS) using a debugger.

This approach has a problem that the developer refers to the source code of the application, thus increasing a work burden on the developer. This approach has a problem that the approach may not be applied to a situation where the developer is not able to refer to the source code of the application. This approach has a problem that a large volume of rework is likely to result if the application is to be modified as a result of conducting the performance verification of the application.

It is possible to generate a model representing a system by utilizing a queuing theory, examine the presence or absence of resource contention, properties thereof, or the like based on the generated model, and conduct the performance verification of the application. The model is defined by a combination of parameters A, B, C, and D. The parameter A represents a distribution of system utilization probability, for example. The parameter B represents a distribution of occupancy time spans of the resources. The parameter C represents a number of resources that may be utilized simultaneously. The parameter D indicates whether or not it is possible to wait for a resource to be secured.

For example, the developer generates a model by observing the system, estimating the combination of the parameters A, B, C, and D, substituting the combination into a prototype of the model. Based on the generated model, the developer examines the presence or absence of resource contention, properties thereof, or the like, and conducts the performance verification of the application. For example, the developer observes the system by adding a log output function to the source code of the application.

This approach has a problem that model generation is difficult. For example, since the developer observes the system and estimates the combination of the parameters A, B, C, and D, there is a problem that the work burden on the developer increases. For example, there is a problem that this approach may not be applied to the situation where the developer is not able to modify the source code of the application.

The present embodiment describes an information processing method that may make it easier to examine the presence or absence of resource contention caused by software, properties thereof, or the like.

In FIG. 1, the information processing apparatus 100 includes an OS 110. The OS 110 has a function for securing any resources managed by the OS 110. The OS 110 has a function for releasing any resources managed by the OS 110.

The information processing apparatus 100 has, for example, a program 101 that monitors the functions possessed by the OS 110. The information processing apparatus 100 has a first program that monitors a function for securing the resources managed by the OS 110, among the functions possessed by the OS 110. The first program acquires a first log related to the function for securing the resources managed by the OS 110 when the software secures the resource managed by the OS 110. The first log includes, for example, information that allows for identification of the resource secured by the software and a time point when the software secures the resource.

The first program monitors, for example, the function for securing the resources managed by the OS 110 and acquires, via a kernel of the OS 110, identification information that allows for identification of the software that secures the resources managed by the OS 110. The first program acquires the first log when it is determined based on the acquired identification information, for example, that the software that secures the resources managed by the OS 110 is a target software 120. Here, the first log includes, for example, information that allows for identification of the resource secured by the target software 120 and the time point when the target software 120 secures the resource. The first program is prepared and executed outside the function for securing the resources managed by the OS 110.

The information processing apparatus 100 has, for example, a second program that monitors the function for releasing the resources managed by the OS 110, among the functions possessed by the OS 110. The second program acquires a second log related to the function for releasing the resources managed by the OS 110 when the software releases the resources managed by the OS 110. The second log includes information that allows for identification of the resource released by the software and a time point when the software releases the resource.

The second program monitors, for example, the function for releasing the resources managed by the OS 110 and acquires, via the kernel of the OS 110, identification information that allows for identification of the software that releases the resources managed by OS 110. The second program acquires the second log when it is determined based on the acquired identification information, for example, that the software that releases the resources managed by the OS 110 is the target software 120. Here, the second log includes, for example, information that allows for identification of the resource released by the target software 120 and the time point when the target software 120 releases the resource. The second program is prepared and executed outside the function for releasing the resources managed by the OS 110.

The target software 120 secures the resources managed by the OS 110. The target software 120 secures the resource by, for example, calling the function for securing the resources managed by the OS 110 among the functions possessed by the OS 110. The target software 120 secures the resource by, for example, calling the function for securing the resources managed by the OS 110 in response to a request, and performs processing corresponding to the request, using the secured resource.

The target software 120 releases the resources managed by the OS 110. The target software 120 releases the resource by, for example, calling the function for releasing the resources managed by OS 110 among the functions possessed by the OS 110. The target software 120 releases the secured resource, by, for example, calling the function for releasing the resources managed by the OS 110 when the target software 120 completes the processing corresponding to the request. The target software 120 resides, for example, in the information processing apparatus 100. The target software 120 may reside, for example, outside the information processing apparatus 100.

(1-1) The information processing apparatus 100 acquires the first log, using the first program. The information processing apparatus 100 acquires the first log by, for example, executing the first program. This allows the information processing apparatus 100 to identify the time point when the target software 120 secures the resource.

(1-2) The information processing apparatus 100 acquires the second log, using the second program. The information processing apparatus 100 acquires the second log by, for example, executing the second program. This allows the information processing apparatus 100 to identify the time point when the target software 120 releases the resource.

(1-3) Based on the acquired first log and the acquired second log, the information processing apparatus 100 associates a first time point when the target software 120 secures a target resource of the resources managed by the OS 110 with a second time point when the target resource is released. This allows the information processing apparatus 100 to obtain information that is useful when modeling the system. The information processing apparatus 100 may obtain information that allows for identification of occupancy time span of the target resource, for example.

(1-4) The information processing apparatus 100 outputs a pair of the associated first time point and second time point. This allows the information processing apparatus 100 to output the information that is useful when modeling the system. As a result, the information processing apparatus 100 may facilitate modeling of the system. The information processing apparatus 100 may facilitate generation of the model representing the system, for example.

The information processing apparatus 100 may make it easy for the developer to use the model representing the system. Consequently, the information processing apparatus 100 may make it easy for the developer to examine the presence or absence of resource contention, properties thereof, or the like, and conduct the performance verification of the application.

By monitoring the functions possessed by the OS 110, the information processing apparatus 100 may make it easy to examine the presence or absence of resource contention, properties thereof, or the like, without referring to the source code of the application. Therefore, the information processing apparatus 100 is applicable to the situation where reference to the source code of the application is not possible. The information processing apparatus 100 may make it possible for the developer to examine the presence or absence of resource contention, properties thereof, or the like, even without observing the system. The information processing apparatus 100 is applicable to the situation where the developer may not modify the source code of the application. Therefore, the information processing apparatus 100 may reduce the work burden on the developer.

The information processing apparatus 100 may make it easy to examine the presence or absence of resource contention, properties thereof, or the like, without performing the load test using the test data and actually causing the resource contention. Therefore, the information processing apparatus 100 may make it easy to examine the presence or absence of resource contention, properties thereof, or the like, before the development process of the application proceeds to the development process where the load test using the test data is feasible. Consequently, the information processing apparatus 100 may suppress an increase in the rework if the application is modified.

Here, the case is described where the information processing apparatus 100 has the first program and the second program, but the configuration is not limited to this. For example, there may be a case where the information processing apparatus 100 may communicate with another computer having the first program and the second program. In this case, the information processing apparatus 100 acquires the first log and the second log by receiving the first log and the second log from the other computer.

Here, the case is described where the first program acquires the first log when it is determined that the software that secures the resources managed by the OS 110 is the target software 120, but the configuration is not limited to this. For example, there may be a case where the first program acquires the first log, irrespective of whether or not the software that secures the resource managed by the OS 110 is the target software 120. In this case, it is possible that the information processing apparatus 100 extract a first log related to the target software 120 from among the first logs acquired by the first program.

Here, the case is described where the second program acquires the second log when it is determined that the software that released the resources managed by the OS 110 is the target software 120, but the configuration is not limited to this. For example, there may be a case where the second program acquires the second log, irrespective of whether or not the software that releases the resources managed by the OS 110 is the target software 120. In this case, it is possible that the information processing apparatus 100 extract a second log related to the target software 120 from among the second logs acquired by the second program.

Here, the case is described where the information processing apparatus 100 associates the first time point when the target software 120 secures the target resource of the resources managed by the OS 110 with the second time point when the target resource is released, but the configuration is not limited to this. For example, there may be a case where the information processing apparatus 100 determines whether or not the software is the target software 120, after associating the first time point when a software secures the target resource of the resources managed by the OS 110 with the second time point when the target resource is released. In this case, when it is determined that the software is the target software 120, the information processing apparatus 100 outputs the pair of the associated first time point and second time point.

Here, the case is described where the first program is prepared outside the function for securing the resources managed by the OS 110, but the configuration is not limited to this. For example, there may be a case where the first program is added to the inside of the function for securing the resources managed by the OS 110.

Here, the case is described where the second program is prepared outside the function for releasing the resources managed by the OS 110, but the configuration is not limited to this. For example, there may be a case where the second program is added to the inside of the function for releasing the resources managed by the OS 110.

(Example of Application Performance Verification System 200)

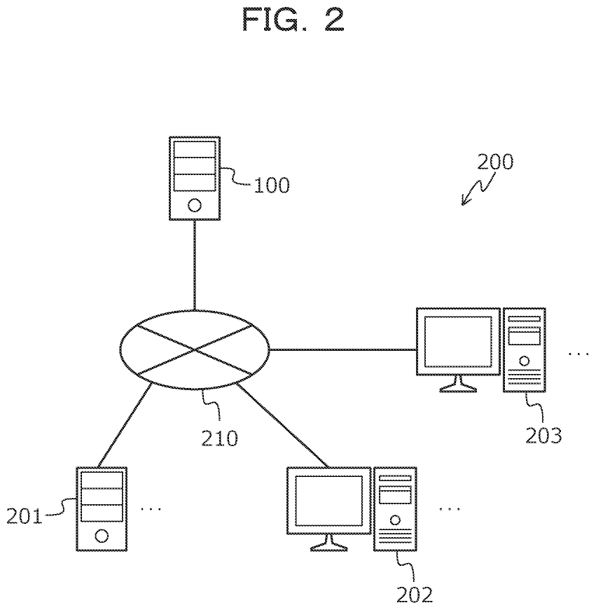

An example of an application performance verification system 200 to which the information processing apparatus 100 illustrated in FIG. 1 is applied will be described with reference to FIG. 2.

FIG. 2 is a diagram illustrating an example of the application performance verification system 200. In FIG. 2, the application performance verification system 200 includes the information processing apparatus 100, an application execution apparatus 201, a client apparatus 202, and a developer apparatus 203.

In the application performance verification system 200, the information processing apparatus 100 and the application execution apparatus 201 are coupled via a wired or wireless network 210. The network 210 is, for example, a local area network (LAN), a wide area network (WAN), the internet, or the like.

In the application performance verification system 200, the application execution apparatus 201 and the client apparatus 202 are coupled via the wired or wireless network 210. In the application performance verification system 200, the information processing apparatus 100 and the developer apparatus 203 are coupled via the wired or wireless network 210.

The information processing apparatus 100 is used by, for example an administrator of the application performance verification system 200. The administrator may be the developer of the target application. The information processing apparatus 100 has an OS. The OS manages resources. The resources are, for example, a DB, a file, or the like. The resources may be a record of the DB or the like. The resources are implemented by the information processing apparatus 100.

The information processing apparatus 100 has a program that monitors functions possessed by the OS. The program acquires a log related to the functions to be monitored. The program monitors the function for securing the resources, for example, and acquires a log including information that allows for identification of the secured resource and the time point when the resource is secured. The program monitors the function for releasing the resources and acquires a log including the information that allows for identification of the released resource and the time point when the resource is released, for example.

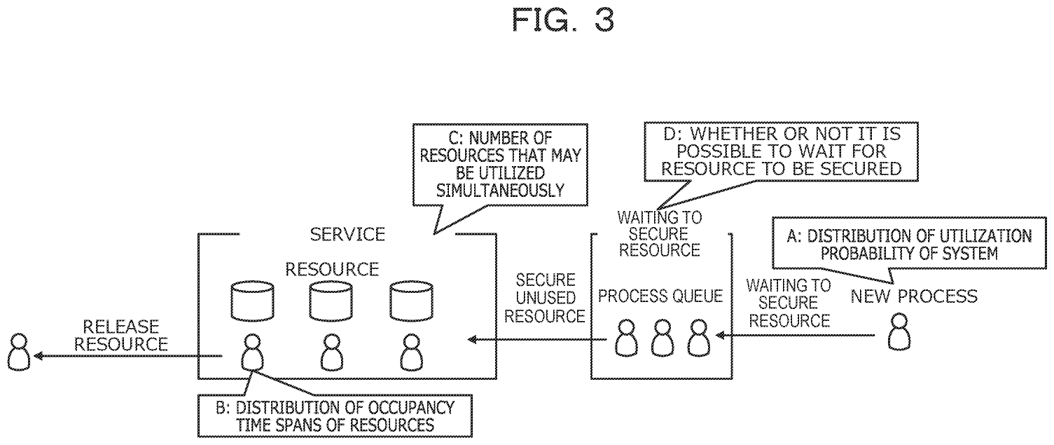

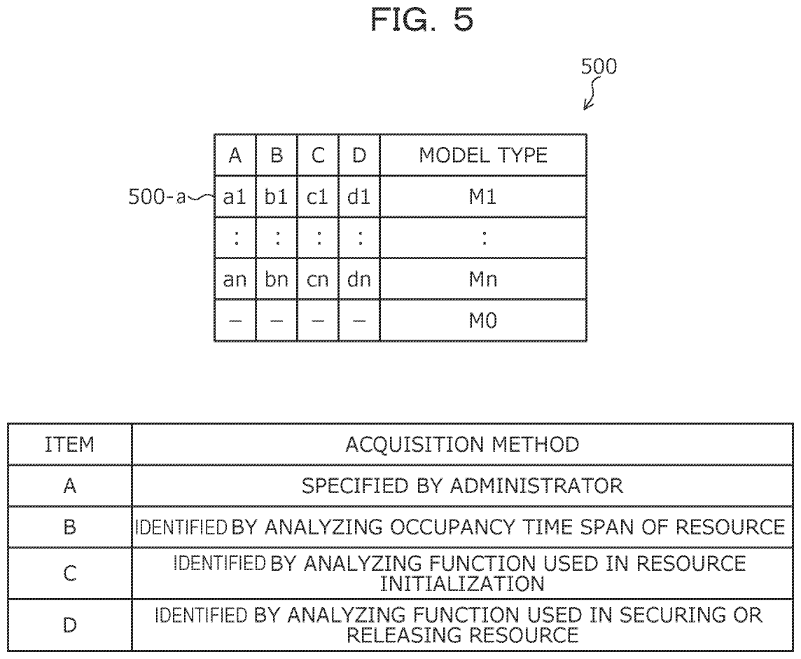

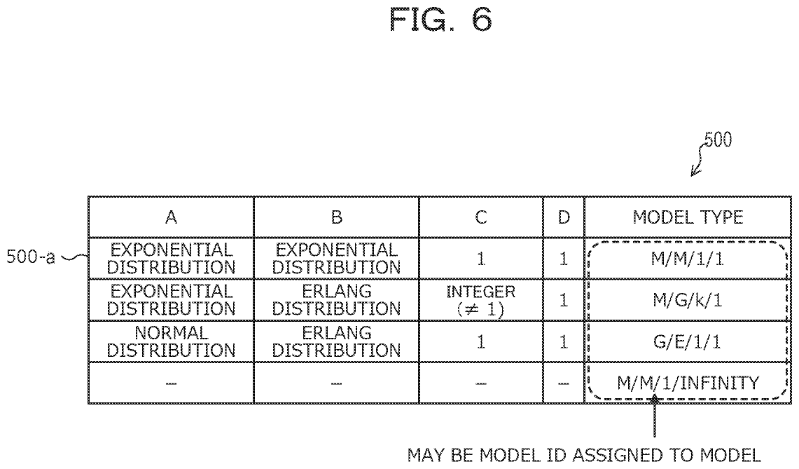

The information processing apparatus 100 stores a plurality of models representing systems. Each model is, for example, a candidate for a model that represents a predetermined system that is implemented by the target application and that provides service. An example of contents of a model is described below with reference to FIG. 3. The target application is executed by the application execution apparatus 201, for example. The information processing apparatus 100 stores the plurality of models using, for example, a model management table 500 to be described below in FIGS. 5 and 6.

The information processing apparatus 100 receives from the target application a call of the function for securing the resources. In response to the call of the function for securing the resources, the information processing apparatus 100 secures the resource with the function for securing the resources. The information processing apparatus 100 acquires the log related to the function for securing the resources, with the program that monitors the function for securing the resources.

The information processing apparatus 100 receives from the target application a call of the function for releasing the resources. In response to the call of the function for releasing the resources, the information processing apparatus 100 releases the resource with the function for releasing the resources. The information processing apparatus 100 acquires the log related to the function for releasing the resources, with the program that monitors the function for releasing the resources.

Based on the acquired logs, the information processing apparatus 100 selects a model that represents the predetermined system implemented by the target application from among the plurality of stored models. For example, the information processing apparatus 100 determines, based on the acquired logs, parameters of the model that represents the system, and select, based on the determined parameters, the model that represents the predetermined system implemented by the target application from among the plurality of models.

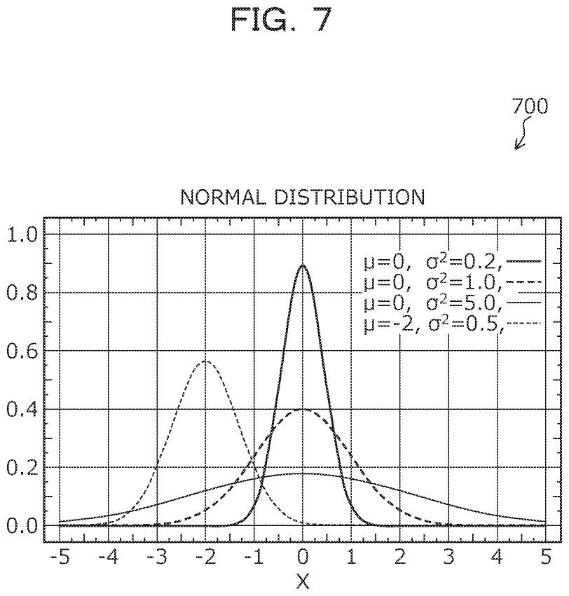

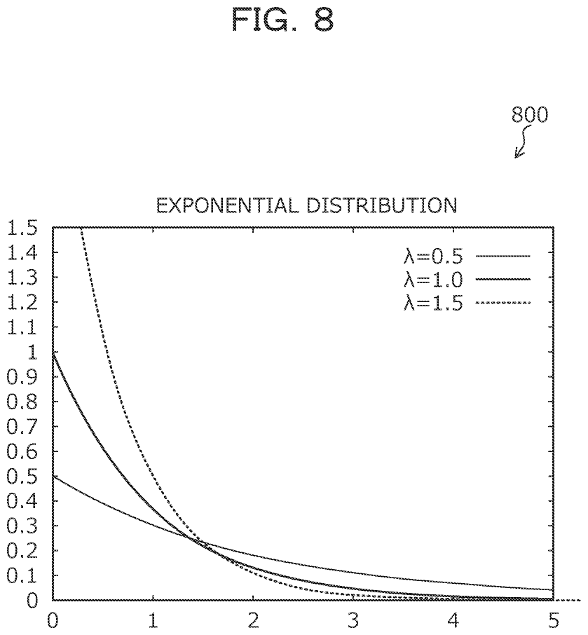

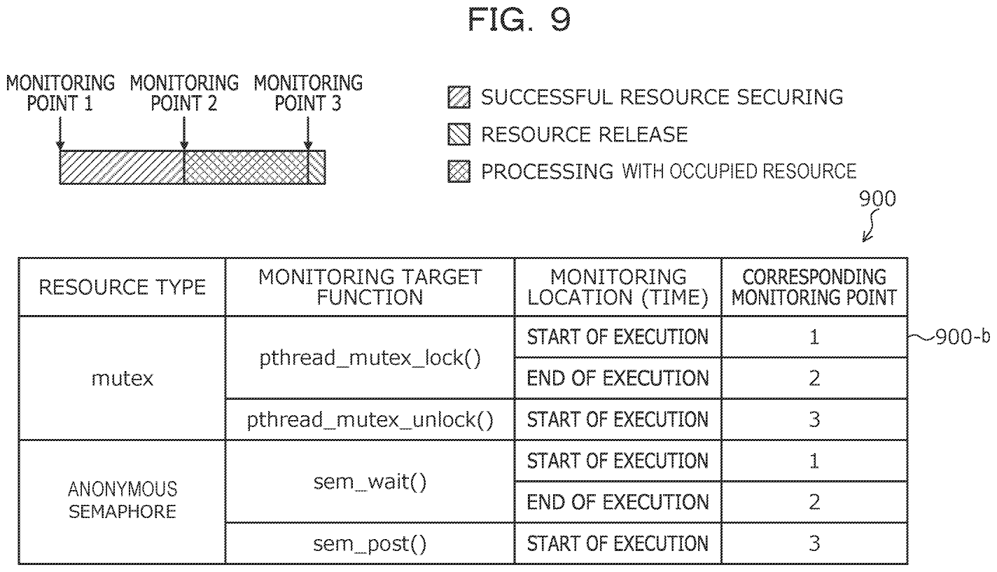

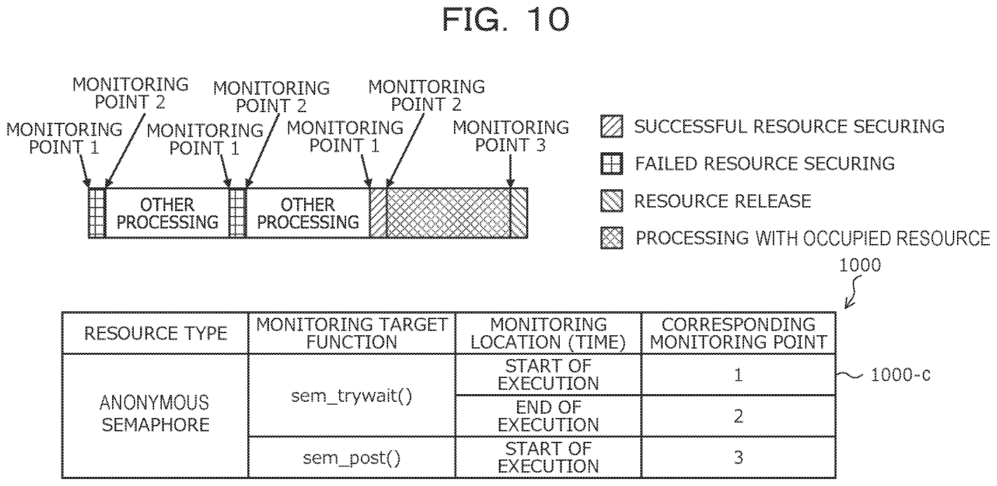

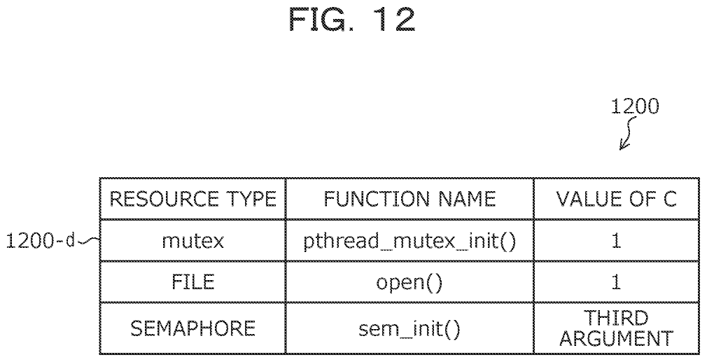

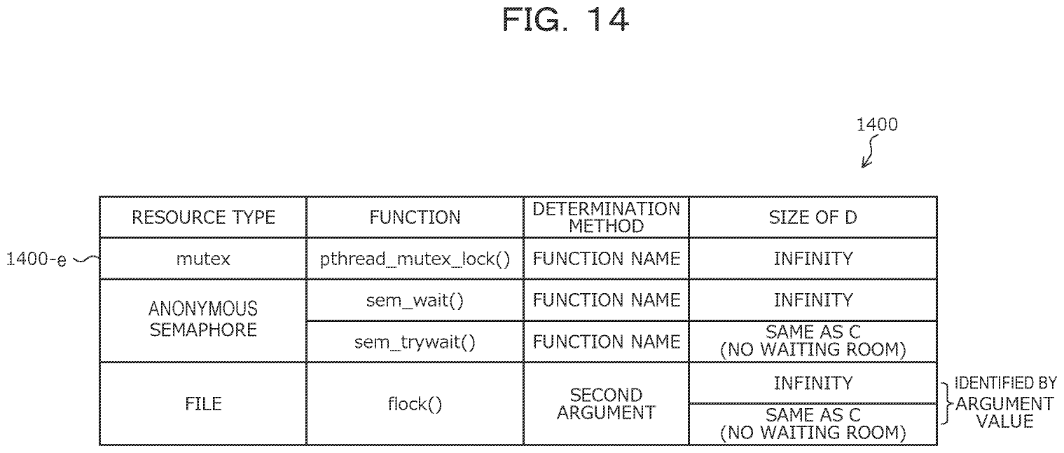

The information processing apparatus 100 identifies the parameter A by accepting the parameter A based on manipulated input of the administrator, for example. The parameter A is defined by, for example, a distribution function to be described below in FIG. 7 or 8. The information processing apparatus 100 identifies the parameter B based on the acquired logs, for example, with reference to various tables to be described below in FIGS. 9 and 10. The information processing apparatus 100 identifies the parameter C based on the acquired logs, for example, with reference to a C judging criterion management table 1200 to be described below in FIG. 12. The information processing apparatus 100 identifies the parameter D based on the acquired logs, for example, with reference to a D judging criterion management table 1400 to be described below in FIG. 14.

The information processing apparatus 100 selects a model corresponding to the combination of the identified parameters A, B, C, and D, as the model representing the predetermined system implemented by the target application, from among the plurality of stored models, for example. The information processing apparatus 100 transmits the selected model to the developer apparatus 203. The information processing apparatus 100 is, for example, a server, a personal computer (PC), or the like.

The application execution apparatus 201 is a computer that executes the target application. The application execution apparatus 201 is used by a provider of the predetermined system implemented by the target application, for example. The application execution apparatus 201 implements the predetermined system that provides services by executing the target application. The application execution apparatus 201 receives, for example, a request for the predetermined system from the client apparatus 202. The application execution apparatus 201 performs processing by the target application, in response to the request, for example.

For example, the application execution apparatus 201 transmits to the information processing apparatus 100 the call of the function for securing the resources, with the target application. For example, with the target application, the application execution apparatus 201 performs the processing corresponding to the request by using the secured resource. For example, with the target application, the application execution apparatus 201 transmits to the information processing apparatus 100 the call of the function for releasing the resources, when completing the processing corresponding to the request. The application execution apparatus 201 is, for example, a server, a PC, or the like.

The client apparatus 202 transmits the request for the predetermined system implemented by the target application, to the application execution apparatus 201. The client apparatus 202 is, for example, a computer used by a user of the predetermined system implemented by the target application. The client apparatus 202 transmits to the application execution apparatus 201 the request for the predetermined system implemented by the target application, based on manipulated input of the user, for example. The client apparatus 202 is, for example, a server, a PC, a tablet terminal, a smartphone, or the like.

The developer apparatus 203 is a computer that receives from the information processing apparatus 100 the model that represents the predetermined system implemented by the target application. The developer apparatus 203 is used by the developer of the target application, for example. Using the received model, the developer apparatus 203 examines the presence or absence of resource contention caused by the target application, properties thereof, or the like in the predetermined system implemented by the target application, and conducts the performance verification of the target application. The developer apparatus 203 outputs a result of the performance verification of the target application conducted so that the developer may refer the result. The developer apparatus 203 is, for example, a server, a PC, a tablet terminal, a smartphone, or the like.

(Example of Contents of Model)

An example of contents of a model will be described with reference to FIG. 3.

FIG. 3 is a diagram illustrating an example of contents of a model. As illustrated in FIG. 3, the model indicates a flow in which a process secures a resource if there is an unused resource, secures a resource after waiting for a resource to be secured if there is no unused resource, and releases the secured resource after occupying the secured resource and receiving the service. The model is defined by a combination of the parameters A, B, C, and D, for example, and indicates the flow described above, with the combination of the parameters A, B, C, and D.

The parameter A represents a distribution of system utilization probability, for example. For example, the parameter A represents a distribution of probabilities that a process attempting to newly secure a resource appears. The process is started by the target application, for example. The parameter B represents a distribution of occupancy time spans of the resources, for example. For example, the parameter B represents the distribution of the occupancy time spans of the resources by the process. The parameter C represents a number of resources that may be utilized simultaneously. In the example of FIG. 3, the parameter C is 3. The parameter D indicates whether or not it is possible to wait for a resource to be secured. For example, if it is possible to wait for a resource to be secured, the parameter D is set to infinity. For example, if it is not possible to wait for a resource to be secured, D is set to a same value as the parameter C.

(Hardware Configuration Example of Information Processing Apparatus 100)

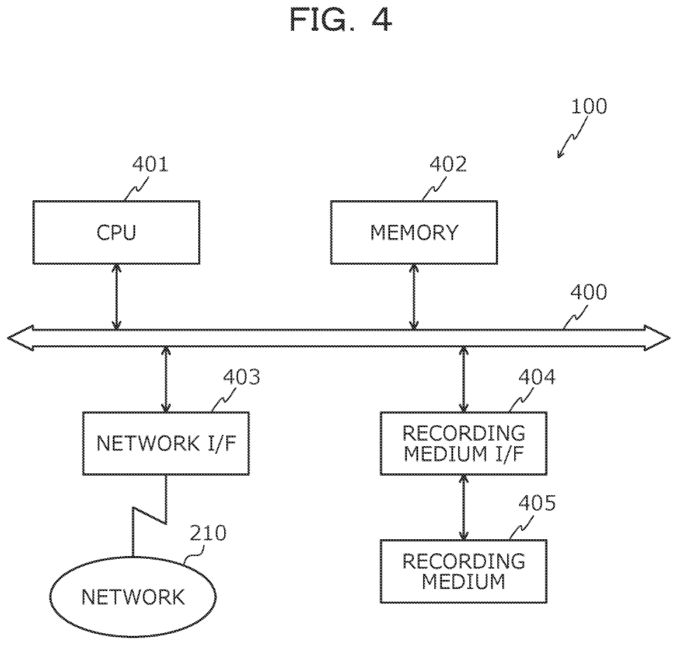

A hardware configuration example of the information processing apparatus 100 will be described with reference to FIG. 4.

FIG. 4 is a block diagram illustrating the hardware configuration example of the information processing apparatus 100. In FIG. 4, the information processing apparatus 100 includes a central processing unit (CPU) 401, a memory 402, a network interface (I/F) 403, a recording medium I/F 404, and a recording medium 405. The individual components are coupled to each other by a bus 400.

The CPU 401 controls the entire information processing apparatus 100. The memory 402 includes, for example, a read-only memory (ROM), a random-access memory (RAM), a flash ROM, or the like. For example, the flash ROM and the ROM store various programs, and the RAM is used as a work area of the CPU 401. The programs stored in the memory 402 causes the CPU 401 to execute coded processing by being loaded into the CPU 401.

The network I/F 403 is coupled to the network 210 through a communication line and is coupled to another computer via the network 210. The network I/F 403 controls interface between the network 210 and inside of the information processing apparatus 100 so as to control an input and an output of data from and to the other computer. The network I/F 403 is, for example, a modem, a LAN adapter, or the like.

The recording medium I/F 404 controls reading/writing of data from/to the recording medium 405 under the control of the CPU 401. The recording medium I/F 404 is, for example, a port for a disk drive, a solid-state drive (SSD), a Universal Serial Bus (USB), or the like. The recording medium 405 is a nonvolatile memory that stores the data written under the control of the recording medium I/F 404. The recording medium 405 is, for example, a disk, a semiconductor memory, a USB memory, or the like. The recording medium 405 may be detachable from the information processing apparatus 100.

In addition to the components described above, the information processing apparatus 100 may include, for example, a keyboard, a mouse, a display, a printer, a scanner, a microphone, a speaker, and the like. The information processing apparatus 100 may include a plurality of recording medium I/Fs 404 or a plurality of recording media 405. The information processing apparatus 100 may not include the recording medium I/F 404 or the recording medium 405.

(Stored Contents of Model Management Table 500)

An example of stored contents of the model management table 500 will be described with reference to FIG. 5. The model management table 500 is implemented by, for example, storage areas such as the memory 402 or the recording medium 405 of the information processing apparatus 100 illustrated in FIG. 4.

FIG. 5 is a diagram illustrating an example of the stored contents of the model management table 500. As illustrated in FIG. 5, the model management table 500 has fields for A, B, C, D, and a model type. In the model management table 500, model management information is stored as a record 500-a by setting, for each model, information in each field. Here, “a” is an arbitrary integer.

The type of the parameter A is set in the field A. The type is, for example, a type of distribution. The type of the parameter B is set in the field B. The type is, for example, a type of distribution. The type of the parameter C is set in the field C. The type is, for example, a range of values that the parameter C may take. The type of the parameter D is set in the field D. The type is a value that the parameter D may take. In the field of the model type, the model type defined by the combination of the parameters A, B, C, and D is set.

A value of the parameter A is a value that defines the distribution of utilization probability of the target application. The value of the parameter A is specified by the administrator, for example. A value of the parameter B is a value that defines the distribution of occupancy time spans. The value of the parameter B is identified based on a log, for example. The value of the parameter B is identified by, for example, analyzing the occupancy time span of the resources based on the log.

A value of the parameter C is identified based on a log, for example. The value of the parameter C is identified by, for example, analyzing a function used in resource initialization based on the log. A value of the parameter D is identified based on a log, for example. The value of the parameter D is identified by, for example, analyzing the function used in securing or releasing the resource, based on the log.

(Specific Example of Model Management Table 500)

A specific example of the model management table 500 will be described with reference to FIG. 6.

FIG. 6 is a diagram illustrating a specific example of the model management table 500. As illustrated in FIG. 6, an exponential distribution, a normal distribution, or the like is set in the field A. The exponential distribution, an Erlang distribution, or the like is set in the field B. In the field C, 1 or an integer≠1 is set as the range of the values that the parameter C may take. In the field D, 1 is set as the value that the parameter D may take.

In the example of FIG. 6, for convenience, a character string representing the combinations of the parameters A, B, C, and D is set in the field of the model type. A model ID assigned to a model may be set in the field of the model type.

(Example of Normal Distribution)

An example of the normal distribution, which is a type of the parameter A and is defined by the value of the parameter A, will be described with reference to FIG. 7.

FIG. 7 is a diagram illustrating an example of the normal distribution. As illustrated in a graph 700 of FIG. 7, the parameter A={μ,σ\hat{ }2} defines a shape of the normal distribution. The shape of the normal distribution defined by the parameter A {μ,σ\hat{ }2} represents the distribution of utilization probability of the target application.

(Example of Exponential Distribution)

An example of the exponential distribution, which is a type of the parameter A and is defined by the value of the parameter A, will be described with reference to FIG. 8.

FIG. 8 is a diagram illustrating the example of the exponential distribution. As illustrated in a graph 800 of FIG. 8, the parameter A=λ defines a shape of the exponential distribution. The shape of the exponential distribution defined by the parameter A=λ represents the distribution of utilization probability of the target application.

(Stored Contents of First Monitoring Point Management Table 900)

An example of stored contents of a first monitoring point management table 900 will be described with reference to FIG. 9. The first monitoring point management table 900 is implemented by, for example, the storage areas such as the memory 402 or the recording medium 405 of the information processing apparatus 100 illustrated in FIG. 4.

FIG. 9 is a diagram illustrating an example of the stored contents of the first monitoring point management table 900. As illustrated in FIG. 9, the first monitoring point management table 900 has fields for a resource type, a monitoring target function, a monitoring location (time), and a corresponding monitoring point. In the first monitoring point management table 900, first monitoring point management information is stored as a record 900-b by setting, for each monitoring point, information in each field. Here, “b” is an arbitrary integer.

In the field of the resource type, a resource type for which the occupancy time span is to be analyzed is set. The resource type is, for example, mutex, anonymous semaphore, or the like. In the field of the monitoring target function, a function to be monitored to analyze the occupancy time span of the resource of the above-described type is set. In the field of the monitoring location (time), information indicating which action time of the above-described function is monitored is set. The action is, for example, start of execution or end of execution. In the field of the corresponding monitoring point, information indicating as which type of monitoring point the above-described action is treated is set.

For the resources of the above-described types, a time span from the action time as a monitoring point 2 until the action time as a monitoring point 3 is the occupancy time span of the above-described resources. The first monitoring point management table 900 is used in a case where a lock method of the OS corresponds to blocking lock. The first monitoring point management table 900 may make it possible to identify the parameter B by allowing for identification of the occupancy time span.

(Stored Contents of Second Monitoring Point Management Table 1000)

An example of stored contents of a second monitoring point management table 1000 will be described with reference to FIG. 10. The second monitoring point management table 1000 is implemented by, for example, the storage areas such as the memory 402 or the recording medium 405 of the information processing apparatus 100 illustrated in FIG. 4.

FIG. 10 is a diagram illustrating an example of the stored contents of the second monitoring point management table 1000. As illustrated in FIG. 10, the second monitoring point management table 1000 has fields for a resource type, a monitoring target function, a monitoring location (time), and a corresponding monitoring point. In the second monitoring point management table 1000, second monitoring point management information is stored as a record 1000-c by setting, for each monitoring point, information in each field. Here, “c” is an arbitrary integer.

In the field of the resource type, a resource type for which the occupancy time span is to be analyzed is set. The resource type is, for example, mutex, anonymous semaphore, or the like. In the field of the monitoring target function, a function to be monitored to analyze the occupancy time span of the resource of the above-described type is set. In the field of the monitoring location (time), information indicating which action time of the above-described function is monitored is set. The action is, for example, start of execution or end of execution. In the field of the corresponding monitoring point, information indicating as which type of monitoring point the above-described action is treated is set.

For the resources of the above-described types, a time span from the action time as a monitoring point 2 until the action time as a monitoring point 3 is the occupancy time span of the above-described resources. The second monitoring point management table 1000 is used in a case where the lock method of the OS corresponds to the blocking lock. The second monitoring point management table 1000 may make it possible to identify the parameter B by allowing for identification of the occupancy time span.

(Example of Method of Identifying Parameter C)

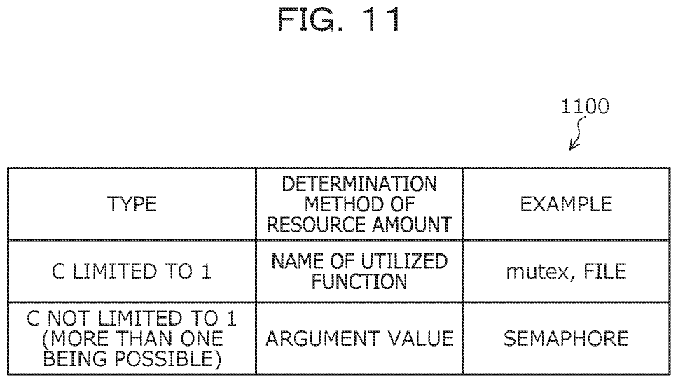

An example of a method of identifying the parameter C will be described with reference to FIG. 11.

FIG. 11 is a diagram illustrating an example of the method of identifying the parameter C. As illustrated in the table 1100 of FIG. 11, it is possible to determine whether or not the parameter C is limited to 1, based on a name of a function for initializing the resource. For example, if the function name is a name corresponding to the mutex or the file, the parameter C is limited to 1. If the parameter C is not limited to 1, it is possible to determine the number of the parameters C based on an argument of the function for initializing the resource. For example, if the function name is a name corresponding to the semaphore, the parameter C is not limited to 1, and a third argument of the function represents the value of the parameter C.

(Stored Contents of C Judging Criterion Management Table 1200)

An example of stored contents of the C judging criterion management table 1200 will be described with reference to FIG. 12. The C judging criterion management table 1200 is implemented by, for example, the storage areas such as the memory 402 or the recording medium 405 of the information processing apparatus 100 illustrated in FIG. 4.

FIG. 12 is a diagram illustrating an example of the stored contents of the C judging criterion management table 1200. As illustrated in FIG. 12, the C judging criterion management table 1200 has fields for a resource type, a function name, and a value of C. In the C judging criterion management table 1200, C judging criterion information is stored as a record 1200-d by setting, for each resource type, information in each field. Here, “d” is an arbitrary integer.

In the field of the resource type, a resource type is set. The resource type is, for example, mutex, file, semaphore, or the like. In the field of the function name, the name of the function for initializing the resource of the above-described type, which acts as a guideline for identifying the parameter C, is set. In the field of the value of C, the value of the parameter C when the function of the above-described name is used is set. The value of C is 1, for example. The value of C is the value of the third argument of the function, for example.

(Example of Method of Identifying Parameter D)

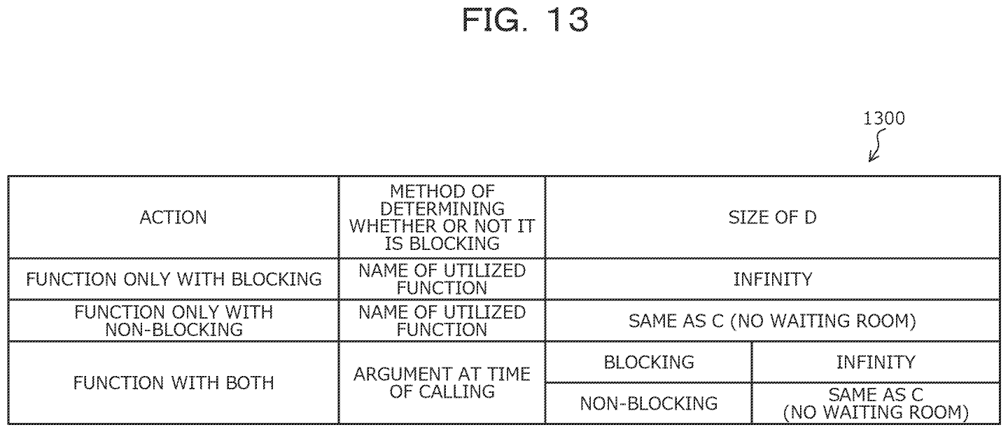

An example of a method of identifying the parameter D will be described with reference to FIG. 13.

FIG. 13 is a diagram illustrating an example of the method of identifying the parameter D. As illustrated in the table 1300 of FIG. 13, if the function may only perform blocking, it is possible to determine that the value of the parameter D is infinity. It is possible to determine the function that may only perform blocking, for example, based on the function name. If the function may only perform non-blocking, it is possible to determine that the value of the parameter D is the same as the value of the parameter C. It is possible to determine the function that may only perform non-blocking, for example, based on the function name.

If the function may perform blocking and non-blocking, it is possible to determine the value of the parameter D based on an argument included in a function call. If the argument included in the function call corresponds to blocking, it is possible to determine that the value of the parameter D is infinity. If the argument included in the function call corresponds to non-blocking, it is possible to determine that the value of the parameter D is the same as the value of the parameter C.

(Stored Contents of D Judging Criterion Management Table 1400)

An example of stored contents of a D judging criterion management table 1400 will be described with reference to FIG. 14. The D judging criterion management table 1400 is implemented by, for example, the storage areas such as the memory 402 or the recording medium 405 of the information processing apparatus 100 illustrated in FIG. 4.

FIG. 14 is a diagram illustrating an example of the stored contents of the D judging criterion management table 1400. As illustrated in FIG. 14, the D judging criterion management table 1400 has fields for a resource type, a function, a determination method, and a size of D. In the D judging criterion management table 1400, D judging criterion information is stored as a record 1400-e by setting, for each function, information in each field. Here, “e” is an arbitrary integer.

In the field of the resource type, a resource type is set. The resource type is, for example, mutex, file, anonymous semaphore, or the like. In the field of the function, a name of the function for securing a resource of the above-described type, which is a guideline for identifying the parameter D, is set. In the field of the determination method, information indicating a determination method to be used when identifying the parameter D to refer to either the above-described name of the function or the above-described second argument of the function is set. In the field of the size of D, the size of the parameter D that is determined by the determination method described above is set. The size of the parameter D is infinity, for example. The size of the parameter D is the same value as the value of the parameter C, for example.

(Hardware Configuration Example of Application Execution Apparatus 201)

A hardware configuration example of the application execution apparatus 201 is the same as, for example, the hardware configuration example of the information processing apparatus 100 illustrated in FIG. 4, and thus a description thereof will be omitted.

(Hardware Configuration Example of Client Apparatus 202)

A hardware configuration example of the client apparatus 202 is the same as, for example, the hardware configuration example of the information processing apparatus 100 illustrated in FIG. 4, and thus a description thereof will be omitted.

(Hardware Configuration Example of Developer Apparatus 203)

A hardware configuration example of the developer apparatus 203 is the same as, for example, the hardware configuration example of the information processing apparatus 100 illustrated in FIG. 4, and thus a description thereof will be omitted.

(Functional Configuration Example of Information Processing Apparatus 100)

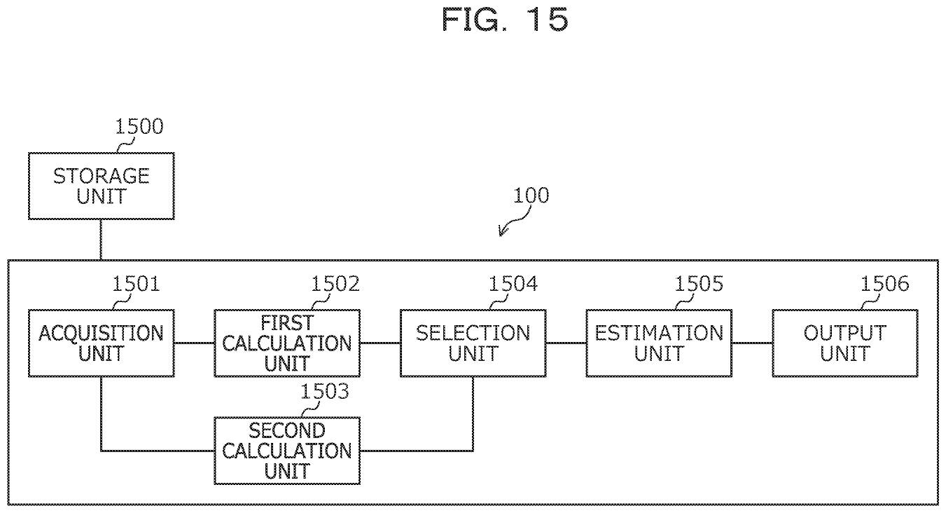

A functional configuration example of the information processing apparatus 100 will be described with reference to FIG. 15.

FIG. 15 is a block diagram illustrating a functional configuration example of the information processing apparatus 100. The information processing apparatus 100 includes a storage unit 1500, an acquisition unit 1501, a first calculation unit 1502, a second calculation unit 1503, a selection unit 1504, an estimation unit 1505, and an output unit 1506.

The storage unit 1500 is implemented by the storage areas such as the memory 402 or the recording medium 405, illustrated in FIG. 4, for example. A case where the storage unit 1500 is included in the information processing apparatus 100 is described below. However, the configuration is not limited to this. For example, there may be a case where the storage unit 1500 is included in an apparatus different from the information processing apparatus 100, and that the stored contents of the storage unit 1500 may be referred to from the information processing apparatus 100.

The acquisition unit 1501 to the output unit 1506 function as an example of a control unit. For example, functions of the acquisition unit 1501 to the output unit 1506 are implemented by causing the CPU 401 to execute the programs stored in the storage areas such as the memory 402 or the recording medium 405 illustrated in FIG. 4, or by using the network I/F 403. A result of processing performed by each of the functional units is stored in, for example, the storage areas such as the memory 402 or the recording medium 405 illustrated in FIG. 4.

The storage unit 1500 stores various information that is referred to or updated in processing of each of the functional units. The storage unit 1500 stores logs related to the function for securing or releasing the resource, for example. The log includes, for example, information that allows for identification of the resource secured or released by the software and the time point when the software secures or releases the resource. The software is, for example, an application. The resources are, for example, a DB, a file, or the like. The resources may be a record of the DB or the like. The resource may be, for example, a computing apparatus such as a server.

The storage unit 1500 stores a first log, for example. The first log includes information that allows for identification of the resource secured by the software and the time point when the software secures the resource. The first log may include attribute information of the function that secures the resource managed by the OS. The attribute information of the function may include, for example, the name of the function, and the argument of the function. The first log is acquired by the acquisition unit 1501, for example.

The storage unit 1500 stores a second log, for example. The second log includes information that allows for identification of the resource released by the software and the time point when the software releases the resource. The second log may include attribute information on the function that releases the resource managed by the OS. The attribute information of the function may include, for example, the name of the function, and the argument of the function. The second log is acquired by the acquisition unit 1501, for example.

The storage unit 1500 stores, for example, attribute information of the function for initializing the resources managed by the OS, among the functions possessed by the OS. The attribute information may include an argument of the function for initializing the resource managed by the OS, for example. The attribute information is acquired by the acquisition unit 1501, for example.

The storage unit 1500 stores prototypes of a plurality of models. A model is obtained by modeling a system including software with the queuing theory. A model is defined by parameters. The storage unit 1500 stores, for example, prototypes of a plurality of models for which parameters are not set. A prototype represents, for example, types of parameters that define a model. The storage unit 1500 stores the model management table 500, for example. The parameters include, for example, a first parameter, a second parameter, a third parameter, and a fourth parameter.

The first parameter is a parameter related to a distribution of software utilization probability. The first parameter represents, for example, the normal distribution or the exponential distribution. The first parameter is, for example, the parameter A described above. The second parameter is a parameter related to a distribution of occupancy time spans from securing to release of the resource managed by the OS. The second parameter represents the Erlang distribution or the exponential distribution, for example. The second parameter is, for example, the parameter B described above. The third parameter is a parameter related to the number of resources possessed by the OS that may be utilized simultaneously. The third parameter is, for example, the parameter C described above. The fourth parameter is a parameter related to whether or not it is possible to wait for a resource managed by the OS to be secured. The fourth parameter is, for example, the parameter D described above.

The acquisition unit 1501 acquires various information used in at least any processing of the functional units. The acquisition unit 1501 stores the acquired various information in the storage unit 1500 or outputs the various acquired information to at least any of the functional units. The acquisition unit 1501 may output the various information stored in the storage unit 1500 to at least any of the functional units. The acquisition unit 1501 may acquire the various information based on manipulated input of the administrator, for example. The acquisition unit 1501 may receive the various information from an apparatus different from the information processing apparatus 100, for example.

The acquisition unit 1501 acquires the first log using the first program. The first program monitors the function for securing the resources managed by the OS, among the functions possessed by the OS. The first program may acquire identification information that allows for identification of software that secures the resource managed by the OS, when the resource managed by the OS is secured, for example.

The first program outputs the first log when it is determined based on the acquired identification information that the software that secures the resource managed by the OS is target software, for example. The first program does not have to output the first log when it is determined based on the acquired identification information that the software that secures the resource managed by the OS is not the target software, for example. The acquisition unit 1501 acquires the first log outputted by the first program, for example. As a result, the acquisition unit 1501 may make it possible to identify the parameter that defines the model.

The acquisition unit 1501 acquires the second log using the second program. The second program monitors the function for releasing the resources managed by the OS, among the functions possessed by the OS. The second program may acquire identification information that allows for identification of software that releases the resource managed by the OS, when the OS releases the resource managed by the OS.

The second program outputs the second log when it is determined based on the acquired identification information that the software that releases the resource managed by the OS is the target software, for example. The second program does not have to output the second log when it is determined based on the acquired identification information that the software that releases the resource managed by the OS is not the target software, for example. The acquisition unit 1501 acquires the second log outputted by the second program, for example. As a result, the acquisition unit 1501 may make it possible to identify the parameter that defines the model.

Using a third program, the acquisition unit 1501 acquires the attribute information of the function for initializing the resource managed by the OS, among the functions possessed by the OS. The third program monitors the function for initializing the resource managed by the OS, among the functions possessed by the OS. The third program acquires and outputs the attribute information of the function for initializing the resource managed by the OS, among the functions possessed by the OS, for example. The acquisition unit 1501 acquires the attribute information outputted by the third program, for example. As a result, the acquisition unit 1501 may make it possible to identify the parameter that defines the model.

The acquisition unit 1501 acquires the first parameter. The acquisition unit 1501 acquires the first parameter by, for example, accepting input of the first parameter, based on the manipulated input of the administrator. The acquisition unit 1501 may acquire the first parameter, for example, by receiving the first parameter from another computer. The other computer is, for example, the developer apparatus 203. This allows the acquisition unit 1501 to obtain a guideline for identifying a model representing a system including software.

The acquisition unit 1501 may accept a start trigger for starting processing performed by any of the functional units. The start trigger is, for example, predetermined manipulated input by the administrator. The start trigger may be, for example, receipt of predetermined information from another computer. The start trigger may be, for example, output of the predetermined information by any of the functional units.

The acquisition unit 1501 may accept, as the start trigger for starting processing performed by each functional unit, receipt of a model generation request from the developer apparatus 203, for example. The acquisition unit 1501 may accept, as the start trigger for starting processing performed by each functional unit, accumulation of a certain number or larger of the first logs and the second logs.

Based on the acquired first log and the acquired second log, the first calculation unit 1502 associates the first time point when the software secures the target resource of the resources managed by the OS with the second time point when the software releases the target resource. The first calculation unit 1502 extracts, for example, a first log including information that allows for identification of the target resource, among the acquired first logs. The first calculation unit 1502 extracts, for example, a second log including the information that allows for identification of the target resource, among the acquired second logs.

The first calculation unit 1502 selects any of the extracted first logs, and identifies a second log which includes a time point that is after the time point included in the selected first log and which is closest to the time point included in the selected first log, for example. The first calculation unit 1502 associates the first time point included in the selected first log with the second time point included in the identified second log. This allows the first calculation unit 1502 to identify the occupancy time span of the target resource.

The first calculation unit 1502 identifies a parameter when modeling the system including the software, based on a pair of the associated first time point and second time point. The first calculation unit 1502 identifies the second parameter, for example. The first calculation unit 1502, for example, calculates the occupancy time span of the target resource based on the pair of the associated first time point and second time point. The first calculation unit 1502, for example, identifies the second parameter based on the calculated occupancy time span. This allows the first calculation unit 1502 to select a model prototype and generate a model.

Based on the acquired first log and the acquired second log, the first calculation unit 1502 may, for example, associate the first time point when the software secures the target resource, among the resources managed by the OS, with the second time point when the software releases the target resource. Subsequently, when the first time point and the second time point are associated for any software, the first calculation unit 1502 may determine whether or not the software is the target software, for example. If the first calculation unit 1502 determines that the software is the target software, for example, the first calculation unit 1502 may calculate the occupancy time span based on the pair of the associated first time point and second time point. The first calculation unit 1502 may, for example, identify the second parameter based on the calculated occupancy time span. This allows the first calculation unit 1502 to select a model prototype and generate a model.

The second calculation unit 1503 identifies the third parameter, based on the acquired attribute information of the function for initializing the resource managed by the OS. The second calculation unit 1503 identifies that the third parameter is 1, for example, when a name of the function included in the acquired attribute information of the function for initializing the resource managed by the OS corresponds to mutex or a file. For example, when the name of the function included in the acquired attribute information of the function for initializing the resource managed by the OS corresponds to the semaphore, the second calculation unit 1503 identifies that the third parameter is a value represented by an argument of the function. This allows the first calculation unit 1502 to select a model prototype and generate a model.

The second calculation unit 1503 identifies the fourth parameter, based on the attribute information of the function for securing the resources managed by the OS, the attribute information being included in the extracted first log. For example, when it is determined that the function for securing the resources managed by the OS corresponds to blocking based on the attribute information of the function that is included in the extracted first log, the second calculation unit 1503 identifies that the fourth parameter is a value that indicates it is not possible to wait for a resource managed by the OS to be secured. For example, when it is determined that the function for securing the resources managed by the OS corresponds to non-blocking based on the attribute information of the function that is included in the extracted first log, the second calculation unit 1503 identifies that the fourth parameter is infinity. This allows the first calculation unit 1502 to select a model prototype and generate a model.

The selection unit 1504 refers to the storage unit 1500 and selects a prototype of any model of the plurality of models, based on the identified parameters. The selection unit 1504 selects a prototype of a model that corresponds to the acquired combination of the first parameter type, second parameter type, third parameter type, and fourth parameter type, for example. This allows the selection unit 1504 to select a prototype of a model that appropriately represents the system including the software.

The selection unit 1504 generates a model. The selection unit 1504 generates a model, for example, by setting the acquired combination of the first parameter, second parameter, third parameter, and fourth parameter for the prototype of the selected model. This allows the selection unit 1504 to generate the model that appropriately represents the system including the software and to make it easier to examine presence or absence of resource contention caused by the software, the properties thereof, or the like.

Using the generated model, the estimation unit 1505 examines the presence or absence of resource contention caused by the software, properties thereof, or the like, and conducts performance verification of the software. Using the generated model, for example, the estimation unit 1505 calculates the maximum utilization frequency of the software in a case where no resource contention is caused. This allows the estimation unit 1505 to reduce the work burden on the developer when examining the presence or absence of resource contention caused by the software, properties thereof, or the like.

The output unit 1506 outputs a result of processing performed by at least any of the functional units. The output is in the form of displaying on a display, print outputting to a printer, transmitting to an external apparatus by the network I/F 403, or storing into the storage areas such as the memory 402 or the recording medium 405, for example. This allows the output unit 1506 to notify the administrator of the result of processing by at least any of the functional units and to improve convenience of the information processing apparatus 100.

The output unit 1506 outputs, for example, the pair of the associated first time point and second time point. The output unit 1506, for example, transmits the pair of the associated first time point and second time point to another computer. The other computer is, for example, the developer apparatus 203. Thus, the output unit 1506 allows the other computer to identify the occupancy time span of the target resource and identify the second parameter.

When the first time point and the second time point are associated for any software, the output unit 1506 may, for example, determine whether or not the software is the target software. If it is determined that the software is the target software, the output unit 1506 may output the pair of the associated first time point and second time point. Thus, the output unit 1506 allows the other computer to identify the occupancy time span of the target resource and identify the second parameter

The output unit 1506 outputs the identified second parameter, for example. For example, the output unit 1506 transmits the second parameter to another computer. The other computer is, for example, the developer apparatus 203. Thus, the output unit 1506 allows the other computer to utilize the second parameter and generate the model that represents the system including the software.

The output unit 1506 outputs the identified third parameter, for example. For example, the output unit 1506 transmits the third parameter to another computer. The other computer is, for example, the developer apparatus 203. Thus, the output unit 1506 allows the other computer to utilize the third parameter and generate the model that represents the system including the software.

The output unit 1506 outputs the identified fourth parameter, for example. For example, the output unit 1506 transmits the fourth parameter to another computer. The other computer is, for example, the developer apparatus 203. Thus, the output unit 1506 allows the other computer to utilize the fourth parameter and generate the model that represents the system including the software.

The output unit 1506 outputs a prototype of the selected model, for example. For example, the output unit 1506 transmits the prototype of the selected model to another computer. The other computer is, for example, the developer apparatus 203. Thus, the output unit 1506 allows the other computer to utilize the model prototype and easily generate the model that represents the system including the software.

The output unit 1506 outputs a generated model, for example. For example, the output unit 1506 transmits the generated model to another computer. The other computer is, for example, the developer apparatus 203. Thus, the output unit 1506 allows the other computer to utilize the model and make it easy to examine the presence or absence of resource contention caused by the software, properties thereof, or the like.

The output unit 1506 outputs a result of conducted performance verification of the software, for example. For example, the output unit 1506 transmits to another computer the maximum utilization frequency of the software in a case where no resource contention is caused. The other computer is, for example, the developer apparatus 203. Thus, the output unit 1506 allows the other computer to utilize the result of the conducted performance verification of the software

(First Operation Example of Application Performance Verification System 200)

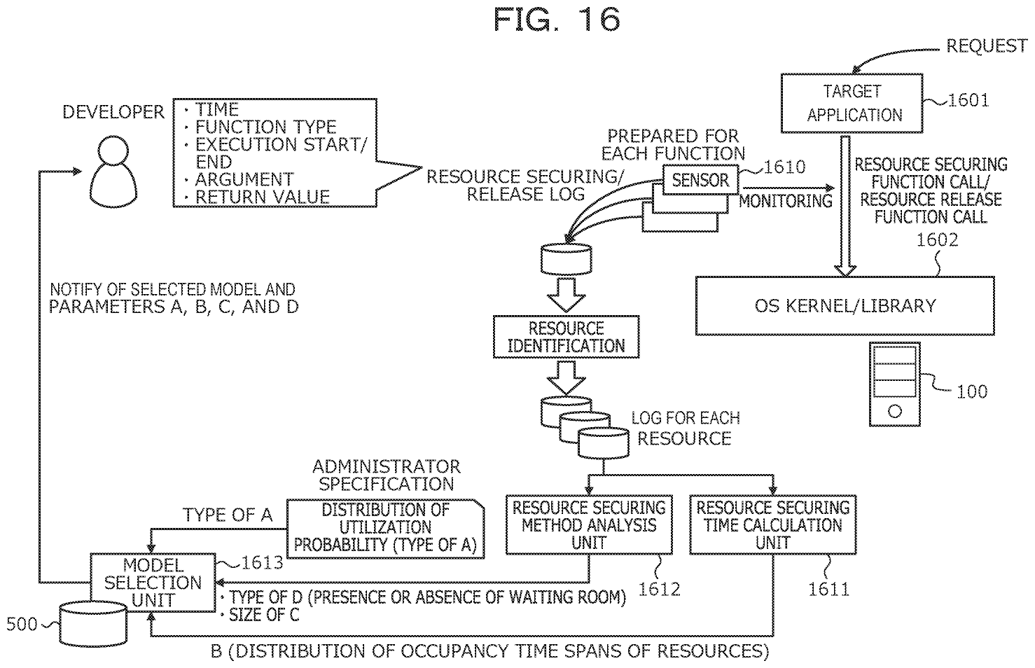

A first operation example of the application performance verification system 200 will be described with reference to FIGS. 16 to 20.

FIGS. 16 to 20 are diagrams illustrating a first operation example of the application performance verification system 200. In FIG. 16, a target application 1601 is executed by the application execution apparatus 201 (illustrated in FIG. 2). There may be some cases where the target application 1601 is executed by the information processing apparatus 100. The information processing apparatus 100 includes an OS 1602. The OS 1602 manages resources. The OS 1602 has the function for initializing the resource, the function for securing the resource, the function for releasing the resource, or the like.

The target application 1601 receives from the client apparatus 202 (illustrated in FIG. 2) a request for a processing to utilize a resource managed by the OS 1602. In response to the request, the target application 1601 transmits a call of the function for securing the resource managed by the OS 1602, to the information processing apparatus 100. The target application 1601 performs, using the secured resource, the processing corresponding to the request. When the target application 1601 completes the processing corresponding to the request, the target application 1601 transmits a call of the function for releasing the resource managed by the OS 1602, to the information processing apparatus 100.

The information processing apparatus 100 has programs that monitor, as sensors 1610, the functions possessed by the OS. The programs are prepared for respective functions possessed by the OS. Any of the sensors 1610, for example, monitors the function for securing the resources and acquires a first log. The first log includes a time point when the resource is secured, a type of the function for securing the resource, whether or not execution of the function for securing the resource has started, whether or not execution of the function for securing the resource has ended, an argument of the function for securing the resource, a return value of the function for securing the resource, or the like.

Any of the sensors 1610, for example, monitors the function for releasing the resource and acquires a second log. The second log includes a time point when the resource is released, a type of the function for releasing the resource, whether or not execution of the function for releasing the resource has started, whether or not execution of the function for releasing the resource has ended, an argument of the function for releasing the resource, a return value of the function for releasing the resource, or the like. Any of the sensors 1610, for example, monitors the function for initializing the resource, and acquires a name and an argument of the function for initializing the resource. The information processing apparatus 100 groups the accumulated first logs and second logs for each target resource.

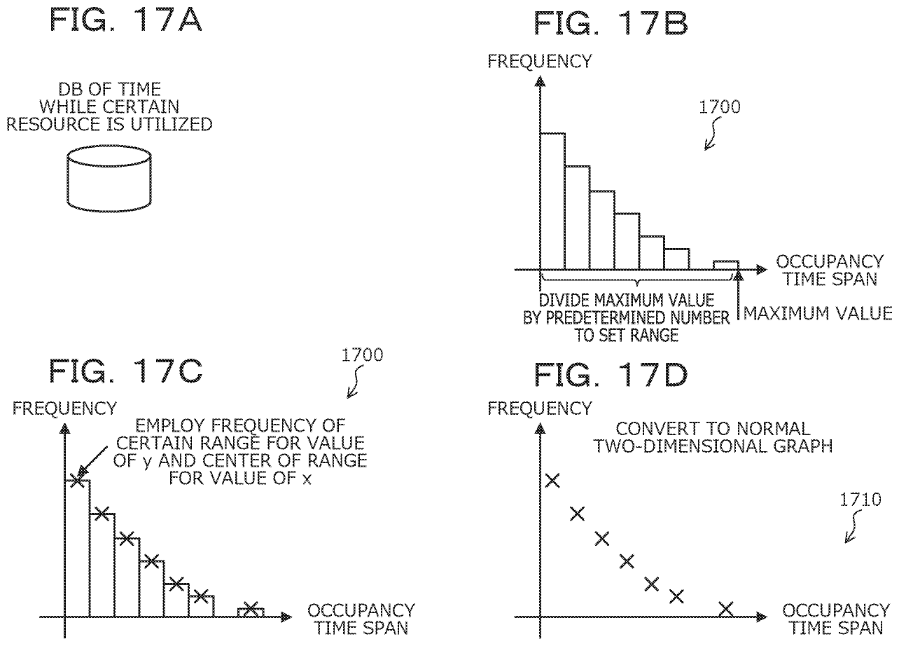

The information processing apparatus 100 includes a resource securing time calculation unit 1611, a resource securing method analysis unit 1612, and a model selection unit 1613. The resource securing time calculation unit 1611 calculates occupancy time span from the first time point when the target resource is secured by the target application 1601 until the second time point when the target resource is released, based on the first logs and the second logs grouped by the target resource. The resource securing time calculation unit 1611 identifies the parameter B based on the calculated occupancy time span. An example of identifying the parameter B will be described below with reference to FIGS. 17A to 19, for example.

The resource securing method analysis unit 1612 refers to the C judging criterion management table 1200 and identifies the parameter C based on the name and argument of the function for initializing the resource, which are acquired by the sensor 1610. The resource securing method analysis unit 1612 refers to the D judging criterion management table 1400 and identifies the parameter D, based on the type of the function for securing the resources and on the argument or return value of the function, which are acquired by the sensor 1610.

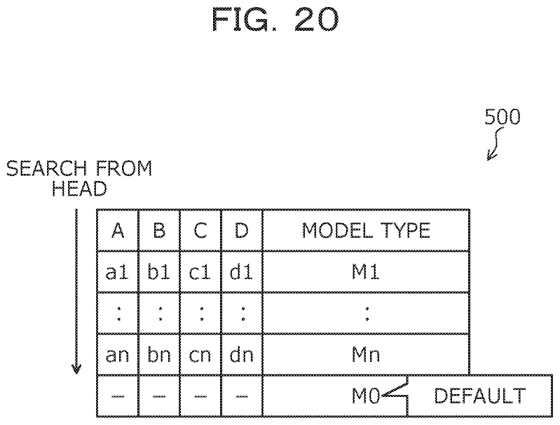

The model selection unit 1613 acquires the parameter A specified by the administrator. The model selection unit 1613 refers to the model management table 500 and selects a type of the model corresponding to the combination of the parameters A, B, C, and D. An example of selecting type of a model will be described below with reference to FIG. 20, for example. The model selection unit 1613 outputs the parameters A, B, C, and D in association with the type of the selected model so that the developer may refer the parameters A, B, C, and D and the type of the selected model. The model selection unit 1613, for example, transmits the parameters A, B, C, and D in association with the type of the selected model, to the developer apparatus 203.

As a result, the information processing apparatus 100 may make it easy for the developer to utilize the model representing the system. Therefore, the information processing apparatus 100 allows the developer to easily examine the presence or absence of resource contention, properties thereof, or the like, by using the model representing the system, and to easily conduct the performance verification of the application. Description continues with FIGS. 17A to 19, and an example of identifying the parameter B will be described.

In FIG. 17A, it is assumed that the information processing apparatus 100 calculates a plurality of occupancy time spans of any target resource, based on the first logs and the second logs grouped for each target resource.

In FIG. 17B, the information processing apparatus 100 sets a plurality of ranges that the occupancy time span may take. The information processing apparatus 100 calculates a width of each range by dividing a maximum value of the occupancy time span by a predetermined number, and sets the predetermined number of ranges each having the width. The information processing apparatus 100 calculates the number of occupancy time spans included in each range of the plurality of occupancy time spans calculated, and sets the number of occupancy time spans to a frequency corresponding to the range. The information processing apparatus 100 generates a graph 1700 that associates each range with the frequency corresponding to the range. The horizontal axis of the graph 1700 is the occupancy time span. The vertical axis of the graph 1700 is the frequency.

In FIG. 17C, based on the graph 1700, the information processing apparatus 100 makes a median of each range x, and identifies coordinates (x, y) with the frequency corresponding to the range being y.

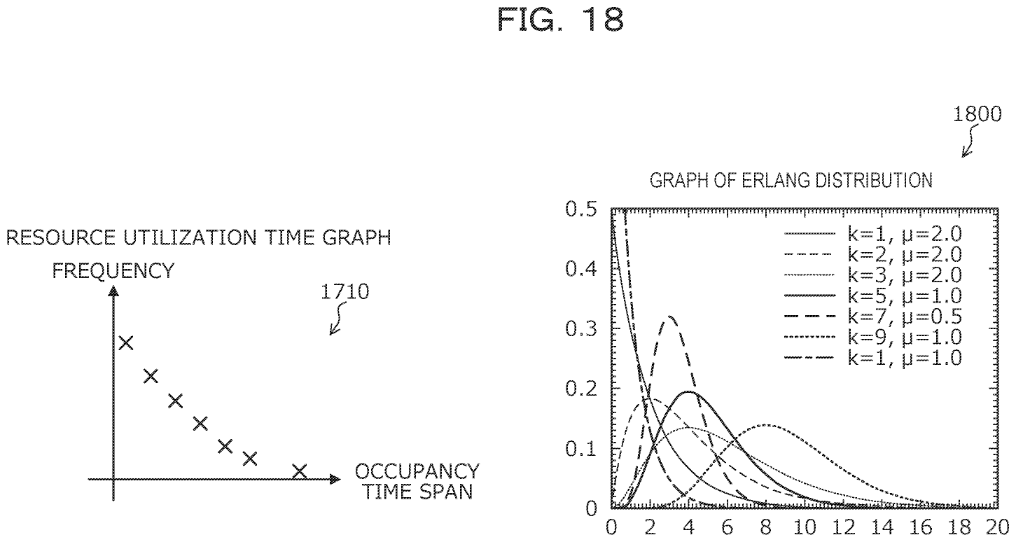

In FIG. 17D, the information processing apparatus 100 generates a two-dimensional graph 1710 including the identified coordinates (x, y). The horizontal axis of the two-dimensional graph 1710 is the occupancy time span. The vertical axis of the two-dimensional graph 1710 is the frequency. Description continues with reference to FIG. 18.

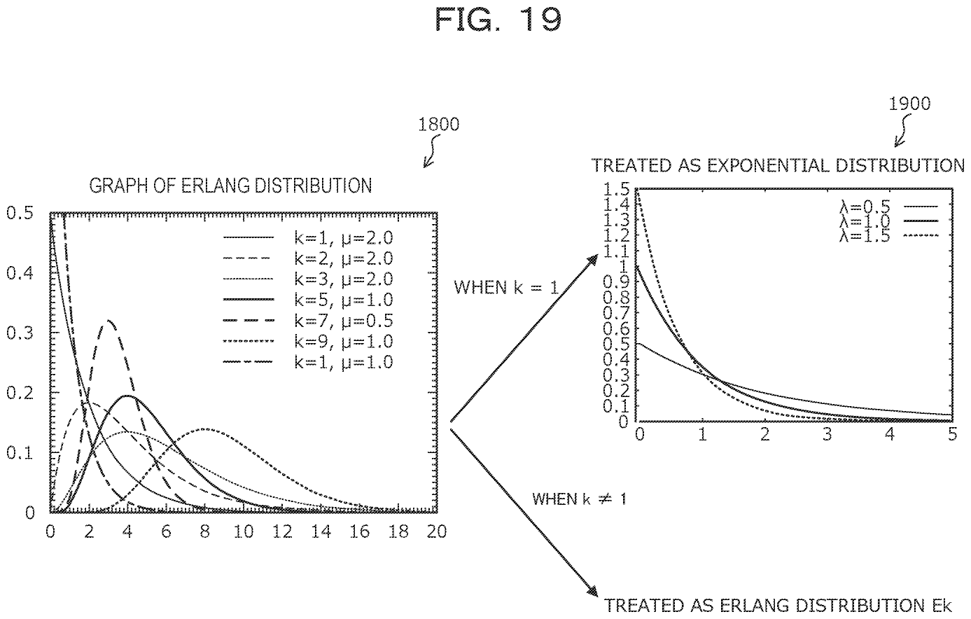

In FIG. 18, the information processing apparatus 100 determines which characteristic curve of a plurality of characteristic curves, each defined by different parameters, illustrated in a graph 1800 matches the two-dimensional graph 1710. The information processing apparatus 100 calculates a degree of approximation of the Erlang distribution and the two-dimensional graph 1710 by, for example, varying parameters (k, p) of the Erlang distribution. For example, the information processing apparatus 100 identifies the parameters (k, p) of the Erlang distribution that makes the calculated degree of approximation largest, and identifies the Erlang distribution defined by the identified parameters (k, p). Description continues with reference to FIG. 19.

In FIG. 19, if the parameter k of the identified Erlang distribution is k=1, the information processing apparatus 100 may treat the type of the parameter B as the exponential distribution illustrated in a graph 1900, instead of the Erlang distribution, because the Erlang distribution mathematically matches the exponential distribution. The information processing apparatus 100 identifies a parameter λ of the exponential distribution based on the parameters (k, μ). The information processing apparatus 100 determines that the type of the parameter B is the exponential distribution, and sets the parameter B=λ.

If the parameter k of the identified Erlang distribution is k≠1, the information processing apparatus 100 determines that the type of the parameter B is the Erlang distribution and sets the parameter B=(k, μ). This allows the information processing apparatus 100 to automatically identify the parameter B and to reduce the work burden on the developer. Description continues with reference to FIG. 20 and an example of selecting a model type will be described.

In FIG. 20, the information processing apparatus 100 searches for a record, in sequence, in which the combination of the parameters A, B, C, and D is set, from the first record in the model management table 500. If the information processing apparatus 100 finds the record in which the combination of the parameters A, B, C, and D is set, the information processing apparatus 100 selects a model type set for the record.

If the information processing apparatus 100 does not find the record in which the combination of the parameters A, B, C, and D is set, the information processing apparatus 100 selects a default model type set for the last record in the model management table 500. This allows the information processing apparatus 100 to select an appropriate model type. The information processing apparatus 100 may select the default model type even when there is no model type corresponding to the combination of the parameters A, B, C, and D, and allows the developer to easily use the model.

Here, the case where the sensor 1610 is provided outside among the functions possessed by the OS is described, but the configuration is not limited to this. For example, there may be a case where the program, which is the sensor 1610, is incorporated in the functions possessed by the OS. In this case, the sensor 1610 may output an ID of the sensor 1610 itself as information representing a type of function, for example, when the function is executed.

(First Monitoring Process Procedure)

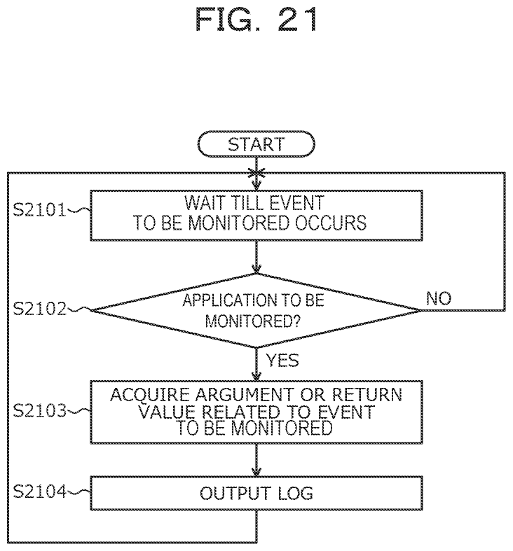

An example of a first monitoring process procedure performed by the information processing apparatus 100 will be described with reference to FIG. 21. A first monitoring process is implemented by the CPU 401, the storage areas such as the memory 402 or the recording medium 405, and the network I/F 403 illustrated in FIG. 4, for example.

FIG. 21 is a flowchart illustrating the example of the first monitoring process procedure. In FIG. 21, the sensor 1610 of the information processing apparatus 100 waits until an event to be monitored occurs (step S2101).

When the event to be monitored occurs, the information processing apparatus 100 determines, with the sensor 1610, whether or not a source of the event to be monitored is an application to be monitored (step S2102). If the source is not the application to be monitored (step S2102: No), the information processing apparatus 100 returns to the processing in step S2101. If the source is the application to be monitored (step S2102 Yes), the information processing apparatus 100 shifts to the processing of step S2103.

In step S2103, the information processing apparatus 100 acquires, with the sensor 1610, an argument or a return value related to the event to be monitored (step S2103). With the sensor 1610, the information processing apparatus 100 outputs a log including time, a name of a function to be monitored, a type of the event to be monitored that has occurred, and the acquired argument or return value (step S2104). The information processing apparatus 100 accumulates the outputted log and returns to the processing in step S2101. This allows the information processing apparatus 100 to accumulate information that is a guideline for identifying parameters.

(Calculation Process Procedure)

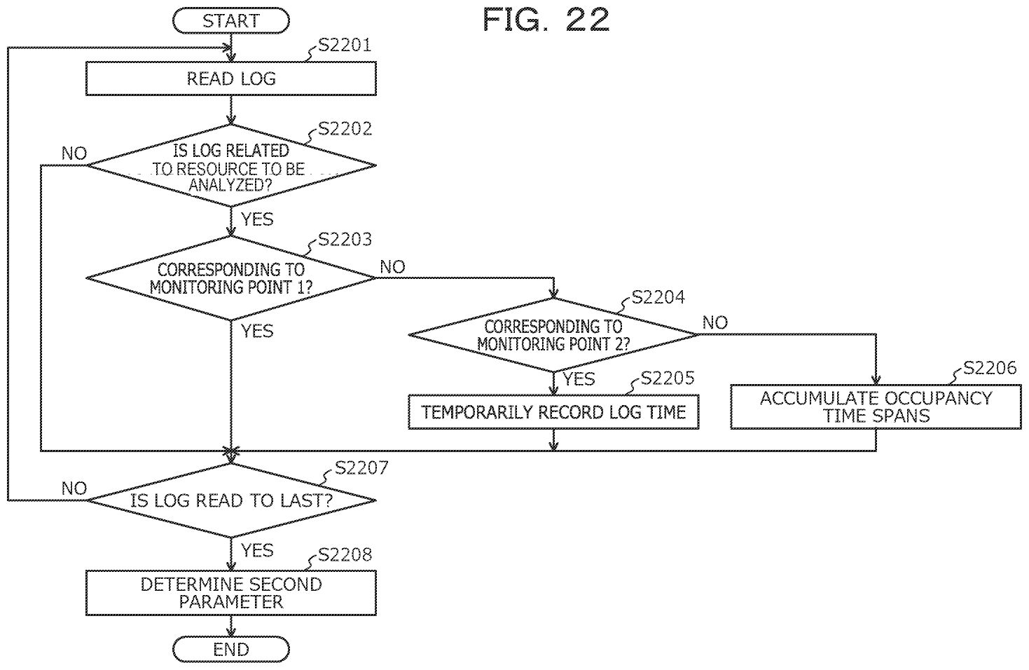

An example of a calculation process procedure performed by the information processing apparatus 100 will be described with reference to FIG. 22. The calculation process is implemented by, for example, the CPU 401, the storage areas such as the memory 402 or the recording medium 405, and the network I/F 403 illustrated in FIG. 4.

FIG. 22 is a flowchart illustrating an example of the calculation process procedure. In FIG. 22, the information processing apparatus 100 reads a log from the accumulated logs (step S2201).

The information processing apparatus 100 determines whether or not the read log is a log related to a resource to be analyzed (step S2202). If the read log is not the log related to the resource to be analyzed (step S2202: No), the information processing apparatus 100 shifts to the processing of step S2207. If the read log is the log related to the resource to be monitored (step S2202: Yes), the information processing apparatus 100 shifts to the processing of step S2203.

In step S2203, the information processing apparatus 100 determines whether or not the read log corresponds to a monitoring point 1 (step S2203). If the read log corresponds to the monitoring point 1 (step S2203: Yes), the information processing apparatus 100 shifts to the processing of step S2207. If the read log does not correspond to the monitoring point 1 (step S2203: No), the information processing apparatus 100 shifts to the processing of step S2204.

In step S2204, the information processing apparatus 100 determines whether or not if the read log corresponds to a monitoring point 2 (step S2204). If the read log corresponds to the monitoring point 2 (step S2204: Yes), the information processing apparatus 100 shifts to the processing of step S2205. If the read log does not correspond to the monitoring point 2 but corresponds to a monitoring point 3 (step S2204: No), the information processing apparatus 100 shifts to the processing of step S2206.

In step S2205, the information processing apparatus 100 temporarily records time of the read log (step S2205). The information processing apparatus 100 shifts to the processing of step S2207.

In step S2206, the information processing apparatus 100 accumulates a difference obtained by subtracting the time of temporarily recorded time from the time of the read log, as an occupancy time span (step S2206). The information processing apparatus 100 shifts to the processing of step S2207.

In step S2207, the information processing apparatus 100 determines whether the log is read to the last (step S2207). If the log is not read to the last (step S2207: No), the information processing apparatus 100 returns to the processing of step S2201. If the log is read to the last (step S2207: Yes), the information processing apparatus 100 shifts to the processing of step S2208.

In step S2208, the information processing apparatus 100 statistically processes the accumulated occupancy time spans, and determines and outputs the parameter B representing any Erlang distribution (step S2208). The information processing apparatus 100 ends the calculation process. This allows the information processing apparatus 100 to obtain a guideline for selecting a model type. The information processing apparatus 100 sets the outputted parameter B for start-up parameters.

(Analysis Process Procedure)

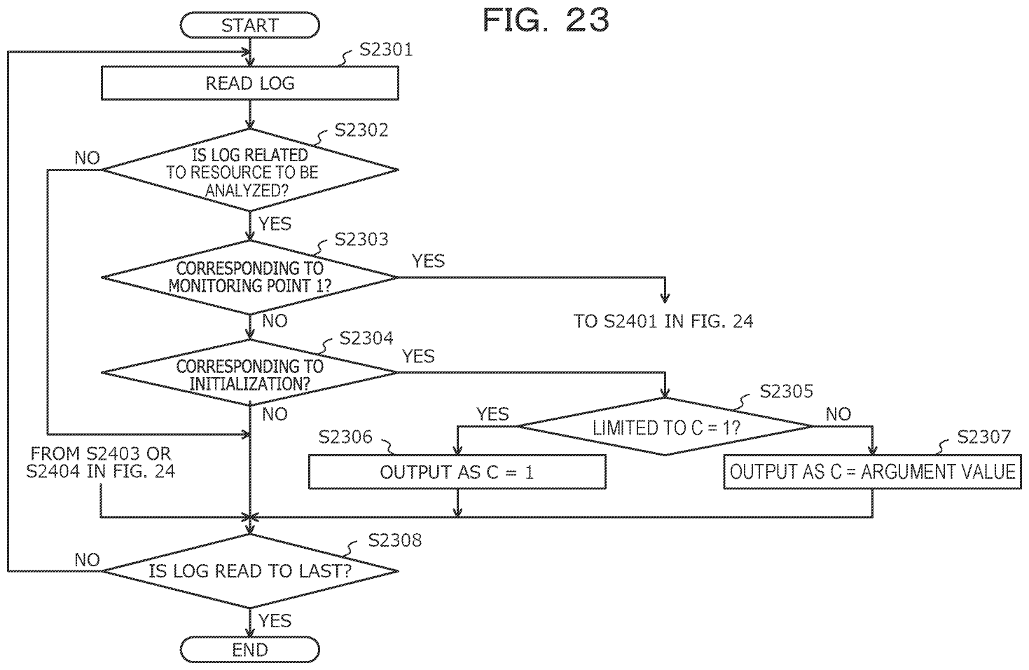

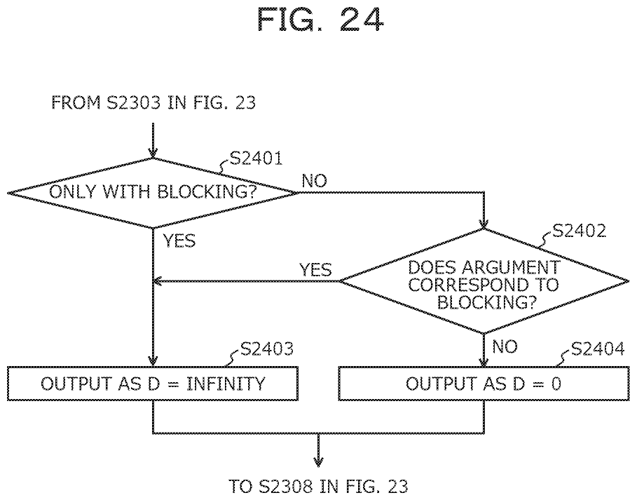

An example of an analysis process procedure performed by the information processing apparatus 100 will be described with reference to FIGS. 23 and 24. The analysis process is implemented by, for example, the CPU 401, the storage areas such as the memory 402 or the recording medium 405, and the network I/F 403 illustrated in FIG. 4.

FIGS. 23 and 24 are flowcharts illustrating an example of the analysis process procedure. In FIG. 23, the information processing apparatus 100 reads a log from the accumulated logs (step S2301).

The information processing apparatus 100 determines whether or not the read log is the log related to the resource to be analyzed (step S2302). If the read log is not the log related to the resource to be analyzed (step S2302: No), the information processing apparatus 100 shifts to the processing of step S2308. If the read log is the log related to the resource to be analyzed (step S2302: Yes), the information processing apparatus 100 shifts to the processing of step S2303.

In step S2303, the information processing apparatus 100 determines whether or not the read log corresponds to the monitoring point 1 (step S2303). If the read log corresponds to the monitoring point 1 (step S2303: Yes), the information processing apparatus 100 shifts to the processing of step S2401 in FIG. 24. If the read log does not correspond to the monitoring point 1 (step S2303: No), the information processing apparatus 100 shifts to the processing of step S2304.

In step S2304, the information processing apparatus 100 determines whether or not the read log corresponds to initialization (step S2304). If the read log corresponds to initialization (step S2304: Yes), the information processing apparatus 100 shifts to the processing of step S2305. If the read log does not correspond to initialization (step S2304: No), the information processing apparatus 100 shifts to the processing of step S2308.

In step S2305, referring to the C judgment criterion table, the information processing apparatus 100 determines whether or not a function type is a type limited to C=1 (step S2305). If the function type is the type limited to C=1 (step S2305: Yes), the information processing apparatus 100 shifts to the processing of step S2306. If the function type is not the type limited to C=1 (step S2305: No), the information processing apparatus 100 shifts to the processing of step S2307.

In step S2306, the information processing apparatus 100 outputs the function type C as C=1 (step S2306). The information processing apparatus 100 shifts to the processing of step S2308.

In step S2307, the information processing apparatus 100 outputs the function type C as C=argument value (step S2307). The information processing apparatus 100 shifts to the processing of step S2308.

In step S2308, the information processing apparatus 100 determines whether or not the log is read to the last (step S2308). If the log is not read to the last (step S2308: No), the information processing apparatus 100 returns to the processing of step S2301. If the log is read to the last (step S2308: Yes), the information processing apparatus 100 ends the analysis process. Description continues with reference to FIG. 24.

In FIG. 24, the information processing apparatus 100 determines whether or not the function type is a type only with blocking (step S2401). If the function type is the type only with blocking (step S2401: Yes), the information processing apparatus 100 shifts to the processing of step S2403. If the function type is not type only with blocking (step S2401: No), the information processing apparatus 100 shifts to the processing of step S2402.

In step S2402, the information processing apparatus 100 determines whether or not an argument corresponds to blocking (step S2402). If the argument corresponds to blocking (step S2402: Yes), the information processing apparatus 100 shifts to the processing of step S2403. If the argument does not correspond to blocking but corresponds to non-blocking (step S2402: No), the information processing apparatus 100 shifts to the processing of step S2404.

In step S2403, the information processing apparatus 100 outputs the function type D as D=infinity (step S2403). The information processing apparatus 100 shifts to the processing of step S2308 in FIG. 23.

In step S2404, the information processing apparatus 100 outputs the function type D as D=0 (step S2404). The information processing apparatus 100 shifts to the processing of step S2308 in FIG. 23. This allows the information processing apparatus 100 to obtain a guideline for selecting a model type. The information processing apparatus 100 sets the outputted parameters C and D as the start-up parameters.

(First Selection Process Procedure)

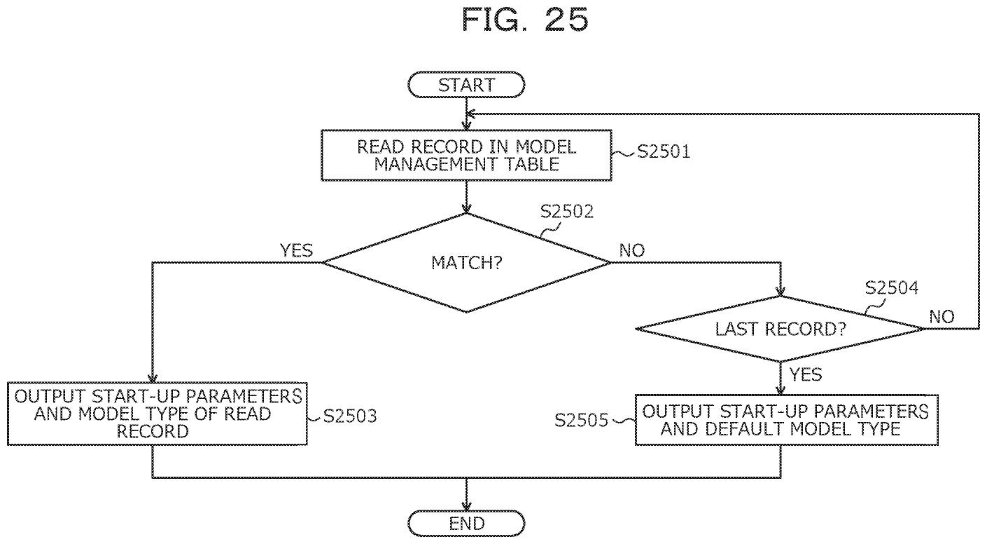

An example of a first selection process procedure performed by the information processing apparatus 100 will be described with reference to FIG. 25. The first selection process is implemented by, for example, the CPU 401, the storage areas such as the memory 402 or the recording medium 405, and the network I/F 403 illustrated in FIG. 4.

FIG. 25 is a flowchart illustrating the example of the first selection process procedure. In FIG. 25, the information processing apparatus 100 reads a record in the model management table 500 (step S2501).

The information processing apparatus 100 compares the read record with the start-up parameters, and determines whether or not types of the parameters set for the read record match types of the start-up parameters (step S2502). If the types of the parameters set for the read record match the types of the start-up parameters (step S2502: Yes), the information processing apparatus 100 shifts to the processing of step S2503. If the types of the parameters set for the read record do not match the types of the start-up parameters (step S2502: No), the information processing apparatus 100 shifts to the processing of step S2504.

In step S2503, the information processing apparatus 100 outputs the start-up parameters and the model type of the read record (step S2503). The information processing apparatus 100 ends the first selection process.

In step S2504, the information processing apparatus 100 determines whether or not the read record is the last record (step S2504). If the read record is not the last record (step S2504: No), the information processing apparatus 100 returns to the processing of step S2501. If the read record is the last record (step S2504: Yes), the information processing apparatus 100 shifts to the processing of step S2505.

In step S2505, the information processing apparatus 100 outputs the start-up parameters and the default model type (step S2505). The information processing apparatus 100 ends the first selection process. As a result, the information processing apparatus 100 may allow the developer to understand an appropriate start-up parameters and an appropriate model type.

(Second Operation Example of Application performance Verification System 200)

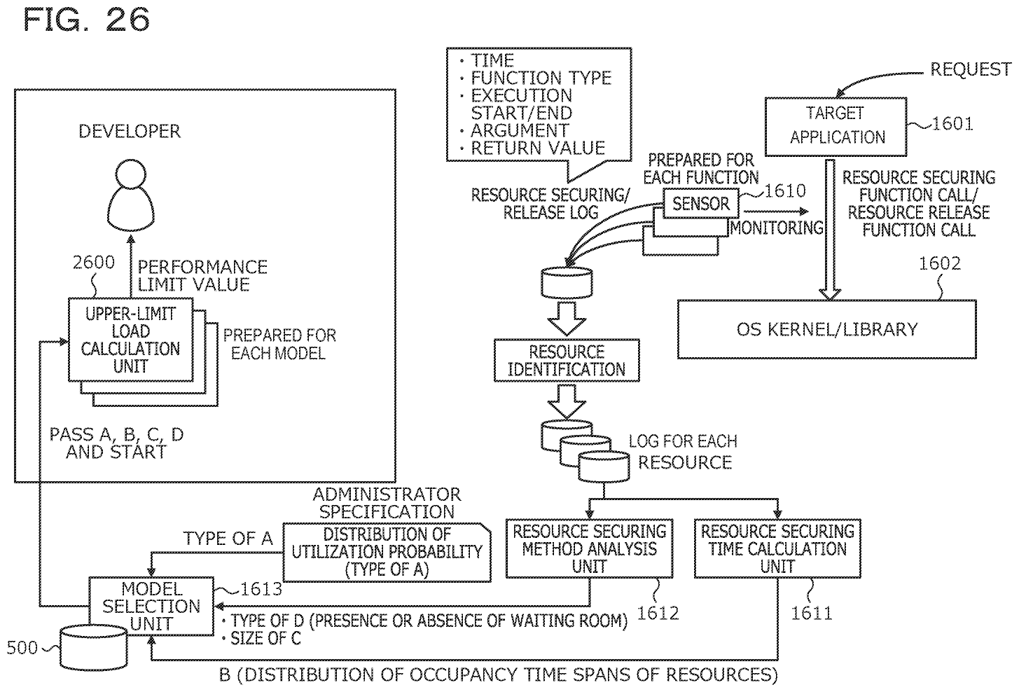

A second operation example of the application performance verification system 200 will be described with reference to FIG. 26. The first operation example described above corresponds to the case where the information processing apparatus 100 transmits the parameters A, B, C, and D in association with the selected model type, to the developer apparatus 203. The second operation example corresponds to a case where the information processing apparatus 100 examines the presence or absence of resource contention, properties thereof, or the like and conducts the performance verification of the target application 1601, based on the parameters A, B, C, and D, and the selected model type.

FIG. 26 is a diagram illustrating the second operation example of the application performance verification system 200. In FIG. 26, similar elements to the elements in FIG. 16 are designated by similar reference numerals to the reference numerals in FIG. 16, and description thereof is omitted. The information processing apparatus 100 includes an upper-limit load calculation unit 2600 responsible for respective models of a plurality of model types. It is assumed that similarly to FIG. 16, the information processing apparatus 100 identifies the parameters A, B, C, and D and selects the model type. The information processing apparatus 100 passes the parameters A, B, C, and D to the upper-limit load calculation unit 2600 responsible for a model of the selected model type, and starts the upper-limit load calculation unit 2600 responsible for the model of the selected model type.

The upper-limit load calculation unit 2600 substitutes the received parameters A, B, C, and D into a model of the model type for which the upper-limit load calculation unit 2600 is responsible, and generates a model. Using the generated model, the upper-limit load calculation unit 2600 examines the presence or absence of resource contention, properties thereof, or the like, and conducts the performance verification of the target application 1601. Using the generated model, the upper-limit load calculation unit 2600 calculates a performance limit value in a case where no resource contention occurs. The performance limit value is the maximum utilization frequency per unit time of the target application 1601.

The upper-limit load calculation unit 2600 transmits the calculated performance limit value to the developer apparatus 203. The developer apparatus 203 receives and outputs the performance limit value so that developer may refer. As a result, the information processing apparatus 100 allows the developer to understand performance of the application. Therefore, the information processing apparatus 100 may reduce the work burden on the developer.

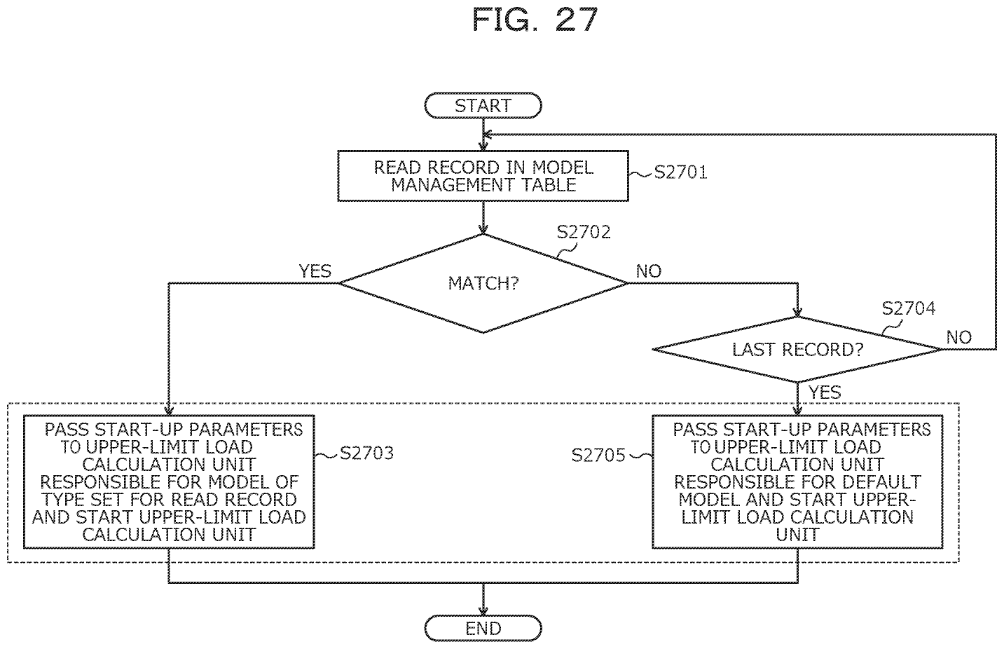

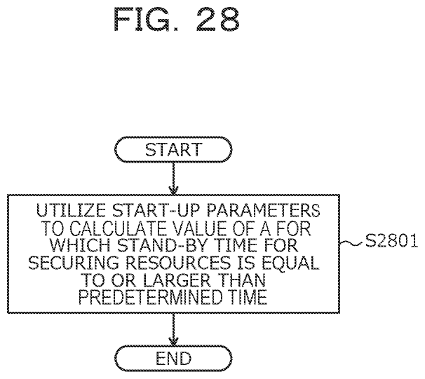

In the second operation example, the information processing apparatus 100 performs, for example, a second selection process to be described below in FIG. 27, instead of the first selection process illustrated in FIG. 25. The upper-limit load calculation unit 2600 performs an estimation process to be described below in FIG. 28, for example.

(Second Selection Process Procedure)

An example of a second selection process procedure performed by the information processing apparatus 100 will be described with reference to FIG. 27. The second selection process is implemented by, for example, the CPU 401, the storage areas such as the memory 402 or the recording medium 405, and the network I/F 403 illustrated in FIG. 4.

FIG. 27 is a flowchart illustrating an example of the second selection process procedure. In FIG. 27, the information processing apparatus 100 reads a record in the model management table 500 (step S2701).

The information processing apparatus 100 compares the read record with the start-up parameters, and determines whether or not types of the parameters set for the read record match the types of the start-up parameters (step S2702). If the types of the parameters set for the read record match the types of the start-up parameters (step S2702: Yes), the information processing apparatus 100 shifts to the processing of step S2703. If the types of the parameters set for the read record do not match the types of the start-up parameters (step S2702: No), the information processing apparatus 100 shifts to the processing of step S2704.

In step S2703, the information processing apparatus 100 passes the start-up parameters to the upper-limit load calculation unit 2600 responsible for the model of the model type set for the read record and starts the upper-limit load calculation unit 2600 (step S2703). The information processing apparatus 100 ends the second selection process.

In step S2704, the information processing apparatus 100 determines whether or not the read record is the last record (step S2704). If the read record is not the last record (step S2704: No), the information processing apparatus 100 returns to the processing of step S2701. If the read record is the last record (step S2704: Yes), the information processing apparatus 100 shifts to the processing of step S2705.

In step S2705, the information processing apparatus 100 passes the start-up parameters to the upper-limit load calculation unit 2600 responsible for the default model, and starts the upper-limit load calculation unit 2600 (step S2705). The information processing apparatus 100 ends the second selection process. This allows the information processing apparatus 100 to start an appropriate upper-limit load calculation unit 2600.

(Estimation Process Procedure)

An example of an estimation process procedure performed by the information processing apparatus 100 will be described with reference to FIG. 28. The estimation process is implemented by, for example, the CPU 401, the storage areas such as the memory 402 or the recording medium 405, and the network I/F 403 illustrated in FIG. 4.

FIG. 28 is a flowchart illustrating the example of the estimation process procedure. In FIG. 28, with the upper-limit load calculation unit 2600, the information processing apparatus 100 calculates a value of A for which standby time for securing resources is equal to or larger than a predetermined time, by utilizing the start-up parameters (step S2801). The information processing apparatus 100 ends the estimation process. This allows the information processing apparatus 100 to examine the presence or absence of resource contention, properties thereof, or the like and conduct the performance verification of the target application 1601.

(Third Operation Example of Application Performance Verification System 200)

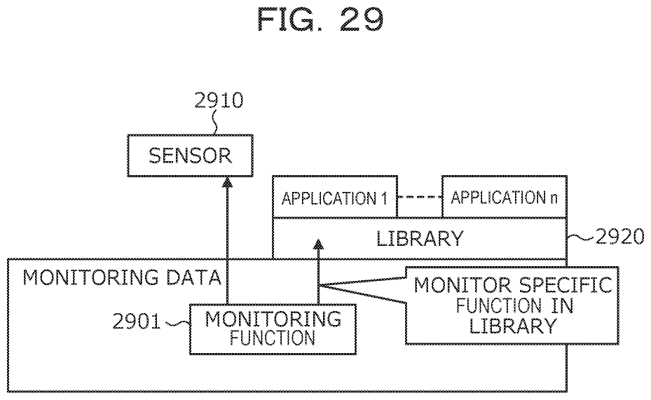

A third operation example of the application performance verification system 200 will be described with reference to FIG. 29. The first operation example described above corresponds to the case where the sensor 1610 monitors the function call. The third operation example corresponds to a case where a sensor 2910 monitors a library 2920.

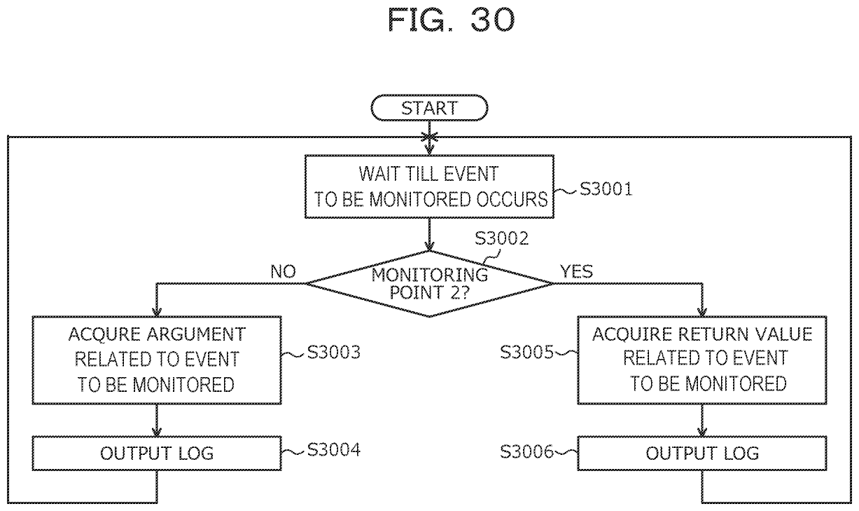

FIG. 29 is a diagram illustrating the third operation example of the application performance verification system 200. In FIG. 29, it is assumed that the application performance verification system 200 includes the library 2920 and the number of computers that manage resources is singular. The computer is, for example, the information processing apparatus 100. The computer has a monitoring function 2901. The monitoring function 2901 monitors a specific function in the library 2920 and transmits monitoring data to the sensor 2910. The specific function is, for example, a blocking resource sharing function. The sensor 2910 detects resource securing or release based on the monitoring data. The sensor 2910 performs, for example, a second monitoring process to be described below in FIG. 30, instead of the first monitoring process illustrated in FIG. 21.

(Second Monitoring Process Procedure)

An example of a second monitoring process procedure performed by the information processing apparatus 100 will be described with reference to FIG. 30. The second monitoring process is implemented by, for example, the CPU 401, the storage areas such as the memory 402 or the recording medium 405, and the network I/F 403 illustrated in FIG. 4.

FIG. 30 is a flowchart illustrating an example of the second monitoring process procedure. In FIG. 30, the information processing apparatus 100 waits until the event to be monitored occurs (step S3001).

The information processing apparatus 100 determines whether or not a type of the event to be monitored is the monitoring point 2 (step S3002). If the type of the event to be monitored is the monitoring point 2 (step S3002: Yes), the information processing apparatus 100 shifts processing of step S3005. If the type of the event to be monitored is not the monitoring point 2 but the monitoring point 1 or 3 (step S3002: No), the information processing apparatus 100 shifts to the processing of step S3003.

In step S3003, the information processing apparatus 100 acquires an argument related to the event to be monitored (step S3003). The information processing apparatus 100 outputs a log including time, a name of the function to be monitored, a type of the event to be monitored that has occurred, and the acquired argument (step S3004). The information processing apparatus 100 returns to the processing of step S3001.

In step S3005, the information processing apparatus 100 acquires a return value related to the event to be monitored (step S3005). The information processing apparatus 100 outputs a log including the time, the name of the function to be monitored, the type of the event to be monitored that has occurred, and the acquired return value (step S3006). The information processing apparatus 100 returns to the processing of step S3001.

(Fourth Operation Example of Application Performance Verification System 200)

A fourth operation example of the application performance verification system 200 will be described. The third operation example described above corresponds to the case where the number of computers that manage the resources is singular. The fourth operation example corresponds to a case where a plurality of computers manages the resources.

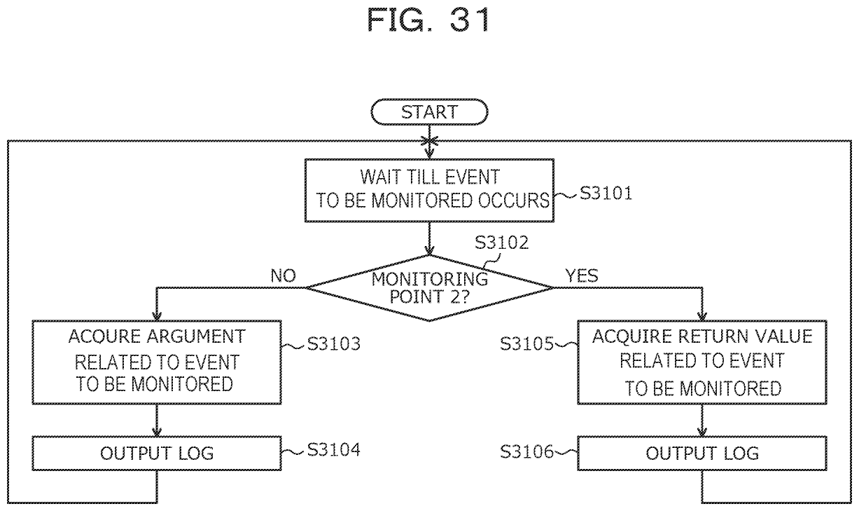

Similarly to FIG. 29, each of the computers has the monitoring function 2901. The sensor 2910 detects resource securing or release based on the monitoring data received from the monitoring function 2901. The sensor 2910 performs, for example, a third monitoring process to be described below in FIG. 31, instead of the first monitoring process illustrated in FIG. 21.

(Third Monitoring Process Procedure)

An example of a third monitoring process procedure performed by the information processing apparatus 100 will be described with reference to FIG. 31. The third monitoring process is implemented by, for example, the CPU 401, the storage areas such as the memory 402 or the recording medium 405, and the network I/F 403 illustrated in FIG. 4.

FIG. 31 is a flowchart illustrating an example of the third monitoring process procedure. In FIG. 31, the information processing apparatus 100 waits until the event to be monitored occurs (step S3101).

The information processing apparatus 100 determines whether or not the type of the event to be monitored is the monitoring point 2 (step S3102). If the type of the event to be monitored is the monitoring point 2 (step S3102: Yes), the information processing apparatus 100 shifts to the processing of step S3105. If the type of the event to be monitored is not the monitoring point 2 but the monitoring point 1, 3 or resource initialization (step S3102: No), the information processing apparatus 100 shifts to the processing of step S3103.

In step S3103, the information processing apparatus 100 acquires an argument related to the event to be monitored (step S3103). The information processing apparatus 100 outputs a log including the time, the name of the function to be monitored, the type of the event to be monitored that has occurred, and the acquired argument (step S3104). The information processing apparatus 100 returns to the processing of step S3101.

In step S3105, the information processing apparatus 100 acquires a return value related to the event to be monitored (step S3105). The information processing apparatus 100 outputs a log including the time, the name of the function to be monitored, the type of the event to be monitored that has occurred, and the acquired return value (step S3106). The information processing apparatus 100 returns to the processing of step S3101.

As described above, according to the information processing apparatus 100, the first log may be acquired by using the first program, the first log including the information that allows for identification of the resource secured by the software and the time point when the software secures the resource. According to the information processing apparatus 100, the second log may be acquired by using the second program, the second log including the information that allows for identification of the resource released by the software and the time point when the software releases the resource. According to the information processing apparatus 100, the first time point when the software secures the target resource of the resources managed by the OS may be, based on the acquired first log and second log, outputted in association with the second time point when the target resource is released. This allows the information processing apparatus 100 to output the information that serves as the guideline for generating the model representing the system including the software, thus making it easy for the developer to utilize the model. Therefore, the information processing apparatus 100 allows the developer to easily examine resource contention caused by the software and may reduce the work burden on the developer.

According to the first program, when the resource managed by the OS is secured, the identification information may be acquired that allows for identification of the software that secures the resource managed by the OS. According to the first program, if it is determined based on the acquired identification information that the software that secures the resource managed by the OS is the target software, the first log may be outputted. According to the second program, when the resource managed by the OS is released, the identification information may be acquired that allows for identification of the software that releases the resource managed by the OS. According to the second program, if it is determined based on the acquired identification information that the software that releases the resource managed by the OS is the target software, the second log may be outputted. This allows the information processing apparatus 100 to extract the first log and the second log related to the target software and efficiently output the information that is the guideline for generating the model of the system including the target software.

According to the information processing apparatus 100, based on the acquired first log and the acquired second log, the first time point when the software secures the target resource of the resources managed by the OS may be associated with the second time point when the software releases the target resource. According to the information processing apparatus 100, if it is determined that the software is the target software, the pair of the associated first time point and second time point may be outputted. This allows the information processing apparatus 100 to extract the pair of the first log and the second log related to the target software and efficiently make available the information that is the guideline for generating the model of the system including the target software.

According to the information processing apparatus 100, the parameters when modeling the system including the software may be identified based on the pair of the associated first time point and second time point. According to the information processing apparatus 100, any model of a plurality of models may be selected, based on the identified parameters, by referring to the storage unit that stores the plurality of models. This allows the information processing apparatus 100 to select an appropriate model. The information processing apparatus 100 allows the developer to omit selection of a model and may reduce the work burden on the developer.

According to the information processing apparatus 100, the first parameter related to the distribution of software utilization probability may be accepted. According to the information processing apparatus 100, any model of the plurality of models may be selected by referring to the storage unit and based on the accepted first parameter and the identified parameters. As a result, the information processing apparatus 100 makes it easy to select an appropriate model with the first parameter.

According to the information processing apparatus 100, the second parameter may be identified based on the pair of the associated first time point and second time point, the second parameter being related to the distribution of occupancy time spans from when the resource managed by the OS is secured until when the resource managed by the OS is released. As a result, the information processing apparatus 100 makes it easy to select an appropriate model with the second parameter.

According to the information processing apparatus 100, the attribute information of the function may be acquired by using the third program that monitors the function for initializing the resource managed by the OS among the functions possessed by the OS. According to the information processing apparatus 100, the third parameter may be identified based on the acquired attribute information of the function for initializing the resource managed by the OS, the third parameter being related to the number of resources possessed by the OS that may be used simultaneously. As a result, the information processing apparatus 100 makes it easy to select an appropriate model with the third parameter.

According to the information processing apparatus 100, the fourth parameter may be identified based on the attribute information of the function for securing the resources managed by the OS. The fourth parameter is related to whether or not it is possible to wait for a resource managed by the OS to be secured. The attribute information is included in the extracted first log. As a result, the information processing apparatus 100 makes it easy to select an appropriate model with the fourth parameter.

According to the information processing apparatus 100, the first parameter representing the normal distribution or the exponential distribution may be utilized. This allows the information processing apparatus 100 to utilize the first parameter that represents the distribution of software utilization probability, with precision.

According to the information processing apparatus 100, the second parameter representing the Erlang distribution may be utilized. This allows the information processing apparatus 100 to utilize the second parameter that represents the distribution of occupancy time spans, with precision.

According to the information processing apparatus 100, if the name of the function included in the attribute information of the function for initializing the resource managed by the OS corresponds to mutex or a file, the third parameter may be identified as being 1. According to the information processing apparatus 100, if the name of the function corresponds to the semaphore, the third parameter may be identified as a value represented by an argument of the function. This allows the information processing apparatus 100 to identify the third parameter with precision.

According to the information processing apparatus 100, if function corresponds to blocking, based on the attribute information of the function for securing the resources managed by the OS, the fourth parameter may be identified as being a value indicating that it is not possible to wait for a resource managed by the OS to be secured. According to the information processing apparatus 100, if the function corresponds to non-blocking, the fourth parameter may be identified as infinity. This allows the information processing apparatus 100 to identify the fourth parameter with precision.

The information processing method described in the embodiment may be implemented by causing a computer, such as a PC or a workstation, to execute a program prepared in advance. The information processing program described in the embodiment is recorded in a computer-readable recording medium and is read from the recording medium by the computer and executed by the computer. The recording medium is a hard disk, a flexible disk, a compact disc (CD)-ROM, a magneto-optical (MO) disk, a Digital Versatile Disc (DVD), or the like. The information processing program included in the embodiment may be distributed via a network, such as the internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program that causes a computer to execute a process, the process comprising:
acquiring a first log using a first program that monitors a first function for securing resources managed by an operating system (OS) among functions possessed by the OS, the first log including information that allows for identification of a resource secured by software and a time point when the software secures the secured resource;
acquiring a second log using a second program that monitors a second function for releasing the resources managed by the OS among the functions possessed by the OS, the second log including information that allows for identification of a resource released by the software and a time point when the software releases the released resource; and
outputting a first time point when the software secures a target resource of the resources managed by the OS in association with a second time point when the target resource is released, based on the acquired first log and the acquired second log.

2. The non-transitory computer-readable recording medium according to claim 1, wherein
the first program acquires, when the secured resource is secured, first identification information that allows for identification of software that secures the secured resource, and outputs the first log when it is determined that the software that secures the secured resource is target software based on the first identification information, and
the second program acquires, when the released resource is released, second identification information that allows for identification of software that releases the released resource, and outputs the second log when it is determined that the software that releases the released resource is the target software based on the second identification information.

3. The non-transitory computer-readable recording medium according to claim 1, the process further comprising:
outputting a pair of the associated first time point and second time point when it is determined that the software that secures the secured resource is target software and that the software that releases the released resource is the target software.

4. The non-transitory computer-readable recording medium according to claim 1, the process further comprising:
identifying parameters in modeling a system including the target software, based on a pair of the associated first time point and second time point; and
selecting, based on the identified parameters, any model of a plurality of models by referring to a storage unit that stores the plurality of models.

5. The non-transitory computer-readable recording medium according to claim 4, the process further comprising:
accepting a first parameter related to a distribution of utilization probability of the target software; and
selecting the any model based on the accepted first parameter and the identified parameters.

6. The non-transitory computer-readable recording medium according to claim 4, the process further comprising:
identifying a second parameter related to a distribution of occupancy time spans from securing to releasing of the target software, based on the pair of the associated first time point and second time point.

7. The non-transitory computer-readable recording medium according to claim 4, the process further comprising:
acquiring attribute information of a third function for initializing the resources managed by the OS among the functions possessed by the OS, using a third program that monitors the third function; and
identifying a third parameter related to a number of resources that are able to be utilized simultaneously among the resources possessed by the OS, based on the acquired attribute information.

8. The non-transitory computer-readable recording medium according to claim 4, wherein
the first log further includes attribute information of the first function, and
the process further comprises:
identifying a fourth parameter related to whether or not it is possible to wait for the resources managed by the OS to be secured, based on the attribute information included in the first log.

9. The non-transitory computer-readable recording medium according to claim 5, wherein
the first parameter represents a normal distribution or an exponential distribution.

10. The non-transitory computer-readable recording medium according to claim 6, wherein
the second parameter represents an Erlang distribution.

11. The non-transitory computer-readable recording medium according to claim 7, wherein
the attribute information of the third function includes a name of the third function and an argument of the third function, and
the process further comprises:
identifying that the third parameter is 1 when the name of the third function corresponds to mutex or a file; and
identifying that the third parameter is a value represented by the argument of the third function when the name of the third function corresponds to a semaphore.

12. The non-transitory computer-readable recording medium according to claim 8, wherein
the attribute information of the first function includes a name of the first function and an argument of the first function, and
the process further comprises:
identifying, when the first function corresponds to blocking, that the fourth parameter is a value indicating that it is not possible to wait for a resource managed by the OS to be secured, based on the attribute information of the first function; and
identifying, when the first function corresponds to non-blocking, that the fourth parameter is infinity, based on the attribute information of the first function.

13. An information processing method, comprising:
acquiring, by a computer, a first log using a first program that monitors a first function for securing resources managed by an operating system (OS) among functions possessed by the OS, the first log including information that allows for identification of a resource secured by software and a time point when the software secures the secured resource;
acquiring a second log using a second program that monitors a second function for releasing the resources managed by the OS among the functions possessed by the OS, the second log including information that allows for identification of a resource released by the software and a time point when the software releases the released resource; and
outputting a first time point when the software secures a target resource of the resources managed by the OS in association with a second time point when the target resource is released, based on the acquired first log and the acquired second log.

14. An information processing apparatus, comprising:
a memory; and
a processor coupled to the memory and the processor configured to:
acquire a first log using a first program that monitors a first function for securing resources managed by an operating system (OS) among functions possessed by the OS, the first log including information that allows for identification of a resource secured by software and a time point when the software secures the secured resource;
acquire a second log using a second program that monitors a second function for releasing the resources managed by the OS among the functions possessed by the OS, the second log including information that allows for identification of a resource released by the software and a time point when the software releases the released resource; and
output a first time point when the software secures a target resource of the resources managed by the OS in association with a second time point when the target resource is released, based on the acquired first log and the acquired second log.
